(19) United States
(12) Patent Application Publication
(10) Pub. No.: US 2024/0365296 A1
(43) Pub. Date: Oct. 31, 2024

(54) INTER-COMMUNICATION TECHNOLOGY AGGREGATION OF ASYNCHRONOUS RADIO FREQUENCY AND VISIBLE LIGHT COMMUNICATION LINKS

(71) Applicant: QUALCOMM Incorporated, San Diego, CA (US)

(72) Inventors: Chao WEI, Beijing (CN); Danlu ZHANG, San Diego, CA (US); Hao XU, Beijing (CN)

(21) Appl. No.: 18/708,526

(22) PCT Filed: Jan. 21, 2022
(86) PCT No.: PCT/CN2022/073093

§ 371 Date: May 8, 2024

(51) Int. Cl. H04W 72/0446; H04B 10/11; H04L 1/1867

(52) U.S. Cl. CPC H04W 72/0446; H04B 10/11; H04L 1/1867

(57) ABSTRACT

Methods, systems, and devices for wireless communications are described. A user equipment (UE) may receive, from a first network device using a first communication technology, an indication of a resource mapping between a first set of time resources for downlink communications using the first communication technology and a second set of time resources for downlink communications using a second communication technology. The UE may determine a timing for receiving a first message from a second network device using the second communication technology based on receiving the indication of the resource mapping. The UE may receive, from the second network device, the first message using the second communication technology based on determining the timing. The UE may transmit, to the first network device, a second message including feedback information using the first communication technology based on receiving the first message from the second network device using the second communication technology.

### CROSS REFERENCE

The present application is a 371 national stage filing of International PCT Application No. PCT/CN2022/073093 by WEI et al. entitled “INTER-COMMUNICATION TECHNOLOGY AGGREGATION OF ASYNCHRONOUS RADIO FREQUENCY AND VISIBLE LIGHT COMMUNICATION LINKS,” filed Jan. 21, 2022, which is assigned to the assignee hereof, and which is expressly incorporated by reference in its entirety herein.

### FIELD OF TECHNOLOGY

The following relates to wireless communications, including inter-communication technology aggregation of asynchronous radio frequency and visible light communication links.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

The described techniques relate to improved methods, systems, devices, and apparatuses that support inter-communication technology aggregation of asynchronous radio frequency and visible light communication links. Generally, the described techniques provide for a user equipment (UE) synchronizing communication timing between a first communication technology and a second communication technology. For example, a base station may transmit an indication of a resource mapping to the UE. The resource mapping may identify one or more associations between a first set of time resources for downlink (DL) communications using the first communication technology and a second set of time resources for DL communications using the second communication technology. Based on the resource mapping, the UE may determine a timing for receiving a message from a network device associated with the second communication technology. In some cases, the network devices may perform feedback and retransmission processes to avoid backhaul delay between the base station associated with the first communication technology and the network device associated with second communication technology. In some cases, one or more network devices (e.g., the UE) may measure a timing drift between resources for the first communication technology and resources for the second communication technology. In response, one or more network devices may reset (e.g., update, align) the resource mapping to correct for the timing drift. The first communication technology may be an example of a radio access technology, such as 5G, 4G, 3G, Wifi, Bluetooth, or others, and the second communication technology may be an example of visible light communications (VLC).

A method for wireless communication at a user equipment (UE) is described. The method may include receiving, from a first network device using a first communication technology, an indication of a resource mapping between a first set of time resources for downlink communications using the first communication technology and a second set of time resources for downlink communications using a second communication technology, determining a timing for receiving a first message from a second network device using the second communication technology based on receiving the indication of the resource mapping, and receiving, from the second network device, the first message using the second communication technology based on determining the timing.

An apparatus for wireless communication at a UE is described. The apparatus may include a processor, memory coupled with the processor, and instructions stored in the memory. The instructions may be executable by the processor to cause the apparatus to receive, from a first network device using a first communication technology, an indication of a resource mapping between a first set of time resources for downlink communications using the first communication technology and a second set of time resources for downlink communications using a second communication technology, determine a timing for receiving a first message from a second network device using the second communication technology based on receiving the indication of the resource mapping, and receive, from the second network device, the first message using the second communication technology based on determining the timing.

Another apparatus for wireless communication at a UE is described. The apparatus may include means for receiving, from a first network device using a first communication technology, an indication of a resource mapping between a first set of time resources for downlink communications using the first communication technology and a second set of time resources for downlink communications using a second communication technology, means for determining a timing for receiving a first message from a second network device using the second communication technology based on receiving the indication of the resource mapping, and means for receiving, from the second network device, the first message using the second communication technology based on determining the timing.

A non-transitory computer-readable medium storing code for wireless communication at a UE is described. The code may include instructions executable by a processor to receive, from a first network device using a first communication technology, an indication of a resource mapping between a first set of time resources for downlink communications using the first communication technology and a second set of time resources for downlink communications using a second communication technology, determine a timing for receiving a first message from a second network device using the second communication technology based on receiving the indication of the resource mapping, and receive, from the second network device, the first message using the second communication technology based on determining the timing.

Some examples of the method, apparatuses, and non-transitory computer-readable medium described herein may further include operations, features, means, or instructions for transmitting, to the first network device, a second message using the first communication technology based on receiving the first message from the second network device using the second communication technology, the second message including feedback information associated with the first message received from the second network device using the second communication technology.

Some examples of the method, apparatuses, and non-transitory computer-readable medium described herein may further include operations, features, means, or instructions for receiving, from the first network device, one or more retransmissions of the first message using the first communication technology, where the one or more retransmissions may be received based on transmitting the second message including feedback information.

Some examples of the method, apparatuses, and non-transitory computer-readable medium described herein may further include operations, features, means, or instructions for transmitting, to the first network device using the first communication technology, a third message including feedback information associated with messages received from the first network device using the first communication technology.

In some examples of the method, apparatuses, and non-transitory computer-readable medium described herein, the third message and the second message may be transmitted using a time-division multiplexing pattern based on a single Tx capability of the UE.

In some examples of the method, apparatuses, and non-transitory computer-readable medium described herein, the third message and the second message may be transmitted simultaneously based on a dual-Tx capability of the UE.

Some examples of the method, apparatuses, and non-transitory computer-readable medium described herein may further include operations, features, means, or instructions for receiving, from the first network device using the first communication technology, control signaling indicating a delay associated with messages communicated using the second communication technology relative to the first communication technology, where receiving the first message using the second communication technology may be based on receiving the control signaling.

In some examples of the method, apparatuses, and non-transitory computer-readable medium described herein, receiving the indication of the resource mapping may include operations, features, means, or instructions for receiving, an indication that the first set of time resources for downlink communications using the first communication technology may be mapped to the second set of time resources for downlink communications using the second communication technology, where receiving, from the second network device, the first message using the second communication technology may be based on receiving the indication.

In some examples of the method, apparatuses, and non-transitory computer-readable medium described herein, receiving the indication of the resource mapping may include operations, features, means, or instructions for receiving, an indication that the second set of time resources for downlink communications using the second communication technology may be mapped to a third set of time resources for uplink communications using the first communication technology and transmitting, to the first network device, a second message using the first communication technology based on receiving the indication, where the second message includes feedback information associated with the first message received from the second network device using the second communication technology.

In some examples of the method, apparatuses, and non-transitory computer-readable medium described herein, receiving the indication of the resource mapping may include operations, features, means, or instructions for receiving, as part of the indication, one or more system frame numbers associated with the first communication technology or the second communication technology or both, one or more frame offsets between the first communication technology and the second communication technology, and one or more slot durations or frame lengths associated with the first communication technology or the second communication technology or both, or any combination thereof and determining a timing for receiving the first message using the second communication technology based on any combination of the one or more system frame numbers, the one or more frame offsets, and the one or more slot durations or frame lengths, where receiving the first message may be based on determining the timing.

Some examples of the method, apparatuses, and non-transitory computer-readable medium described herein may further include operations, features, means, or instructions for aligning a timing associated with the first communication technology and a timing associated with the second communication technology, where the resource mapping between the first set of time resources for downlink communications using the first communication technology and the second set of time resources for downlink communications using the second communication technology may be based on the aligning.

Some examples of the method, apparatuses, and non-transitory computer-readable medium described herein may further include operations, features, means, or instructions for determining a first offset between a time resource associated with the first communication technology and a time resource associated with the second communication technology, determining a second offset between the time resource associated with the first communication technology and the time resource associated with the second communication technology, and determining a difference between the first offset and the second offset corresponding to a timing drift between the first communication technology and the second communication technology.

Some examples of the method, apparatuses, and non-transitory computer-readable medium described herein may further include operations, features, means, or instructions for transmitting an indication of the timing drift to the first network device based on determining the difference associated with the timing drift and adjusting the resource mapping based on the timing drift satisfying a threshold.

In some examples of the method, apparatuses, and non-transitory computer-readable medium described herein, the first network device includes a base station and the second network device includes a visible light communications access point.

In some examples of the method, apparatuses, and non-transitory computer-readable medium described herein, the first communication technology includes a radio access technology and the second communication technology includes visible light communications.

Some examples of the method, apparatuses, and non-transitory computer-readable medium described herein may further include operations, features, means, or instructions for establishing a first communication link with the first network device using the first communication technology and establishing a second communication link with the second network device using the second communication technology, where one or more time resources associated with the first communication link may be asynchronous with one or more time resources associated with the second communication link.

A method for wireless communication at a first network device is described. The method may include determining a resource mapping between a first set of time resources for downlink communications using a first communication technology and a second set of time resources for downlink communications using a second communication technology, transmitting, to a UE using the first communication technology, an indication of the resource mapping, and monitoring for one or more messages from the UE based on the resource mapping.

An apparatus for wireless communication at a first network device is described. The apparatus may include a processor, memory coupled with the processor, and instructions stored in the memory. The instructions may be executable by the processor to cause the apparatus to determine a resource mapping between a first set of time resources for downlink communications using a first communication technology and a second set of time resources for downlink communications using a second communication technology, transmit, to a UE using the first communication technology, an indication of the resource mapping, and monitor for one or more messages from the UE based on the resource mapping.

Another apparatus for wireless communication at a first network device is described. The apparatus may include means for determining a resource mapping between a first set of time resources for downlink communications using a first communication technology and a second set of time resources for downlink communications using a second communication technology, means for transmitting, to a UE using the first communication technology, an indication of the resource mapping, and means for monitoring for one or more messages from the UE based on the resource mapping.

A non-transitory computer-readable medium storing code for wireless communication at a first network device is described. The code may include instructions executable by a processor to determine a resource mapping between a first set of time resources for downlink communications using a first communication technology and a second set of time resources for downlink communications using a second communication technology, transmit, to a UE using the first communication technology, an indication of the resource mapping, and monitor for one or more messages from the UE based on the resource mapping.

Some examples of the method, apparatuses, and non-transitory computer-readable medium described herein may further include operations, features, means, or instructions for receiving, from the UE, a second message using the first communication technology based on the UE receiving a first message using the second communication technology from a second network device and transmitting, via a backhaul connection, to the second network device, feedback information associated with the first message based on receiving the second message from the UE.

Some examples of the method, apparatuses, and non-transitory computer-readable medium described herein may further include operations, features, means, or instructions for transmitting, to the UE, one or more retransmissions of the first message using the first communication technology, where the one or more retransmissions of the first message may be transmitted based on receiving the second message including feedback information.

Some examples of the method, apparatuses, and non-transitory computer-readable medium described herein may further include operations, features, means, or instructions for transmitting, to the UE using the first communication technology, control signaling indicating a delay associated with messages communicated using the second communication technology relative to the first communication technology, where the delay may be associated with the UE receiving the first message using the second communication technology.

In some examples of the method, apparatuses, and non-transitory computer-readable medium described herein, transmitting the indication of the resource mapping may include operations, features, means, or instructions for transmitting, an indication that the first set of time resources for downlink communications using the first communication technology may be mapped to the second set of time resources for downlink communications using the second communication technology, where monitoring for one or more messages from the UE may be based on transmitting the indication.

In some examples of the method, apparatuses, and non-transitory computer-readable medium described herein, transmitting the indication of the resource mapping may include operations, features, means, or instructions for transmitting, an indication that the second set of time resources for downlink communications using the second communication technology may be mapped to a third set of time resources for uplink communications using the first communication technology and receiving, from the UE, a second message using the first communication technology based on transmitting the indication, where the second message includes feedback information associated with a first message received from a second network device using the second communication technology.

In some examples of the method, apparatuses, and non-transitory computer-readable medium described herein, transmitting the indication of the resource mapping may include operations, features, means, or instructions for transmitting, as part of the indication, one or more system frame numbers associated with the first communication technology or the second communication technology or both, one or more frame offsets between the first communication technology and the second communication technology, and one or more slot durations or frame lengths associated with the first communication technology or the second communication technology or both, or any combination thereof.

Some examples of the method, apparatuses, and non-transitory computer-readable medium described herein may further include operations, features, means, or instructions for aligning a timing associated with the first communication technology and a timing associated with the second communication technology, where the resource mapping between the first set of time resources for downlink communications using the first communication technology and the second set of time resources for downlink communications using the second communication technology may be based on the aligning.

Some examples of the method, apparatuses, and non-transitory computer-readable medium described herein may further include operations, features, means, or instructions for receiving, from the UE, an indication of a timing drift corresponding to a measured difference between a first offset and a second offset and adjusting the resource mapping based on the timing drift satisfying a threshold.

Some examples of the method, apparatuses, and non-transitory computer-readable medium described herein may further include operations, features, means, or instructions for receiving, from the UE, using the first communication technology, a third message including feedback information associated with messages received from the first network device using the first communication technology.

In some examples of the method, apparatuses, and non-transitory computer-readable medium described herein, the third message and a second message may be received using a time-division multiplexing pattern based on a single Tx capability of the UE.

A method for wireless communication at a second network device is described. The method may include receiving, from a first network device using a first communication technology, an indication of a resource mapping between a first set of time resources for downlink communications using the first communication technology and a second set of time resources for downlink communications using a second communication technology, determining a timing for transmitting a first message to a UE using the second communication technology based on receiving the indication of the resource mapping, and transmitting, to the UE, the first message using the second communication technology.

An apparatus for wireless communication at a second network device is described. The apparatus may include a processor, memory coupled with the processor, and instructions stored in the memory. The instructions may be executable by the processor to cause the apparatus to receive, from a first network device using a first communication technology, an indication of a resource mapping between a first set of time resources for downlink communications using the first communication technology and a second set of time resources for downlink communications using a second communication technology, determine a timing for transmitting a first message to a UE using the second communication technology based on receiving the indication of the resource mapping, and transmit, to the UE, the first message using the second communication technology.

Another apparatus for wireless communication at a second network device is described. The apparatus may include means for receiving, from a first network device using a first communication technology, an indication of a resource mapping between a first set of time resources for downlink communications using the first communication technology and a second set of time resources for downlink communications using a second communication technology, means for determining a timing for transmitting a first message to a UE using the second communication technology based on receiving the indication of the resource mapping, and means for transmitting, to the UE, the first message using the second communication technology.

A non-transitory computer-readable medium storing code for wireless communication at a second network device is described. The code may include instructions executable by a processor to receive, from a first network device using a first communication technology, an indication of a resource mapping between a first set of time resources for downlink communications using the first communication technology and a second set of time resources for downlink communications using a second communication technology, determine a timing for transmitting a first message to a UE using the second communication technology based on receiving the indication of the resource mapping, and transmit, to the UE, the first message using the second communication technology.

Some examples of the method, apparatuses, and non-transitory computer-readable medium described herein may further include operations, features, means, or instructions for receiving, from the first network device, via a backhaul connection, feedback information associated with the first message.

### BRIEF DESCRIPTION OF THE DRAWINGS

FIG. 1 illustrates an example of a wireless communications system that supports inter-communication technology aggregation of asynchronous radio frequency and visible light communication links in accordance with aspects of the present disclosure.

FIG. 2 illustrates an example of a wireless communications system that supports inter-communication technology aggregation of asynchronous radio frequency and visible light communication links in accordance with aspects of the present disclosure.

FIG. 3 illustrates an example of communication resources that support inter-communication technology aggregation of asynchronous radio frequency and visible light communication links in accordance with aspects of the present disclosure.

FIG. 4 illustrates an example of a wireless communications system that supports inter-communication technology aggregation of asynchronous radio frequency and visible light communication links in accordance with aspects of the present disclosure.

FIG. 5 illustrates an example of a process flow that supports inter-communication technology aggregation of asynchronous radio frequency and visible light communication links in accordance with aspects of the present disclosure.

FIGS. 6 and 7 show block diagrams of devices that support inter-communication technology aggregation of asynchronous radio frequency and visible light communication links in accordance with aspects of the present disclosure.

FIG. 8 shows a block diagram of a communications manager that supports inter-communication technology aggregation of asynchronous radio frequency and visible light communication links in accordance with aspects of the present disclosure.

FIG. 9 shows a diagram of a system including a device that supports inter-communication technology aggregation of asynchronous radio frequency and visible light communication links in accordance with aspects of the present disclosure.

FIGS. 10 and 11 show block diagrams of devices that support inter-communication technology aggregation of asynchronous radio frequency and visible light communication links in accordance with aspects of the present disclosure.

FIG. 12 shows a block diagram of a communications manager that supports inter-communication technology aggregation of asynchronous radio frequency and visible light communication links in accordance with aspects of the present disclosure.

FIG. 13 shows a diagram of a system including a device that supports inter-communication technology aggregation of asynchronous radio frequency and visible light communication links in accordance with aspects of the present disclosure.

FIGS. 14 and 15 show block diagrams of devices that support inter-communication technology aggregation of asynchronous radio frequency and visible light communication links in accordance with aspects of the present disclosure.

FIG. 16 shows a block diagram of a communications manager that supports inter-communication technology aggregation of asynchronous radio frequency and visible light communication links in accordance with aspects of the present disclosure.

FIG. 17 shows a diagram of a system including a device that supports inter-communication technology aggregation of asynchronous radio frequency and visible light communication links in accordance with aspects of the present disclosure.

FIGS. 18 through 23 show flowcharts illustrating methods that support inter-communication technology aggregation of asynchronous radio frequency and visible light communication links in accordance with aspects of the present disclosure.

### DETAILED DESCRIPTION

A wireless communications system may support multiple communication technologies. In some cases, a communication technology may support communications using radio waves and communications using visible light. For visible light communication (VLC), a network device may transmit information using a light source such as a light emitting diode (LED), which may emit light at frequencies faster than a human eye can detect. A receiver, such as a user equipment (UE), may receive the information (e.g., the emitted light) from the network device using a component, which may be a photo-detector, a photo-diode (PD), or an image sensor (IS) (e.g., a camera). In some cases, it may be challenging for the UE to transmit information to a VLC access point (AP) (e.g., using uplink (UL) communications) due to power constraints or other issues (e.g., alignment issues, interference issues) related to communications using visible light. In such cases, it may be desirable for a UE to communicate using two different communication technologies. For example, a UE may be configured to receive downlink communications and transmit uplink communications using a first communication technology (such as 5G or 4G) and may be configured to receive downlink communications using a second communication technology (e.g., VLC).

As described herein, some wireless communications systems may support network devices (e.g., UEs, base stations, VLC devices) that communicate using both radio frequency (RF) based communications and VLCs. However, time-frequency resources for RF-based communications may not be synchronized with time-frequency resources for VLCs. For example, frame structure, slot duration, and other aspects associated with time-frequency resources may not be coordinated or aligned between each communication technology, which may result in scheduling issues and otherwise impair communications between network devices.

In accordance with the techniques described herein, network devices may synchronize communication timing for communications using different communication technologies (e.g., a first communication technology such as a radio access technologies (RATs) and a second communication technology such as VLC technologies). In some cases, a UE may receive DL messages using both a first communication technology (e.g., a RAT) and a second communication technology (e.g., a VLC technology) and may transmit UL messages using the first communication technology (e.g., the RAT). Additionally or alternatively, a network node of the second communication technology (e.g., VLC AP) and the UE may receive, from a base station, an indication of a resource mapping between resources for first communication technology and the second communication technology.

The UE, the base station, and the network device may communicate according to the resource mapping (e.g., the resource mapping may enable the network communication devices to effectively synchronize communications). In some cases, the resource mapping may enable the network devices to effectively perform feedback and retransmission processes, such as hybrid automatic repeat request (HARQ) processes. For example, a network device of the second communication technology (e.g., VLC AP) may transmit a message to a UE. The UE may not be configured for to transmit UL messages using the second communication technology. Consequently, the UE may transmit a feedback message to the base station using the first communication technology, which may indicate if the UE received the message from the network device. The base station may receive the feedback message from the UE and may relay the feedback message to the network device. Accordingly, the network device associated with the second communication technology may determine whether to retransmit the message to the UE based on receiving the feedback message from the base station.

In some cases, the base station may retransmit the message (e.g., the message originally transmitted by the network device associated with the second communication technology) to the UE in order to avoid a delay associated with the backhaul link between the base station and the network device. In some cases, the UE may measure a timing drift between resources for first communication technology (e.g., RF-based technology) and resources for the second communication technology (e.g., VLC technology). For example, an offset between an RF slot and a VLC frame may change over time. The UE may determine that the timing drift exceeds a threshold timing drift and may transmit an indication to the base station. In response, the UE or the base station may reset (e.g., update, align) the resource mapping between the resources of the communication technologies (e.g., to correct for the timing drift).

Aspects of the disclosure are initially described in the context of wireless communications systems. Aspects of the disclosure are further illustrated by and described with reference to apparatus diagrams, system diagrams, flowcharts, process flows, and communication resources that relate to inter-communication technology aggregation of asynchronous radio frequency and visible light communication links.

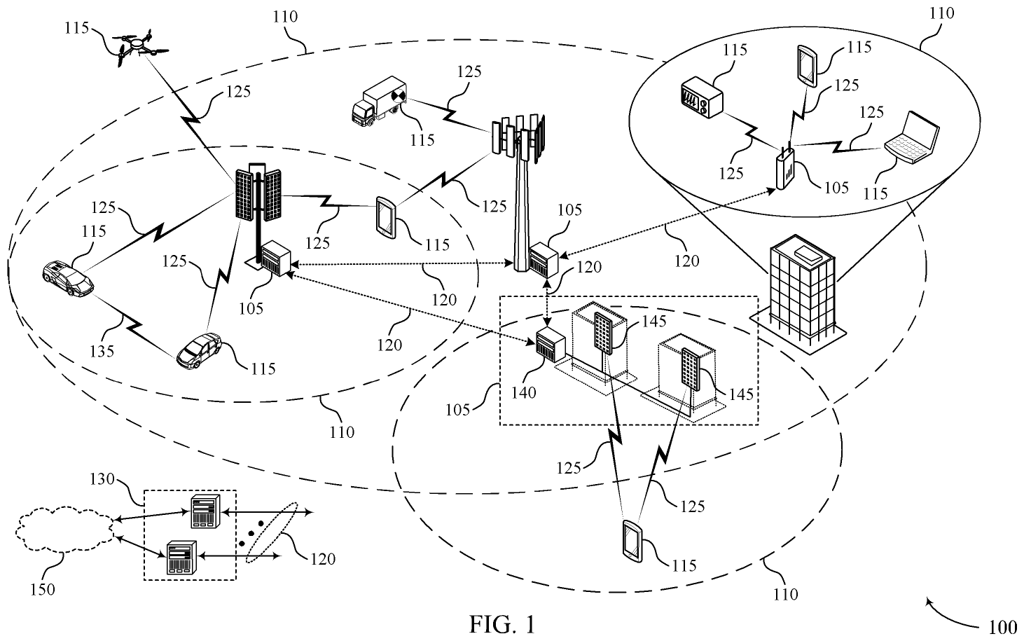

FIG. 1 illustrates an example of a wireless communications system 100 that supports architecture and control for inter-RAT communication technology aggregation in accordance with aspects of the present disclosure. The wireless communications system 100 may include one or more base stations 105, one or more UEs 115, and a core network 130. In some examples, the wireless communications system 100 may be an LTE network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical (PHY) layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple DL component carriers and one or more UL component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a DL carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1: M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include DL transmissions, UL transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the medium access control (MAC) layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In accordance with techniques described herein, one or more network devices may perform one or more methods for synchronizing communication timing between a first communication technology and a second communication technology. For example, the base station 105 may transmit an indication of a resource mapping to the UE 115. The resource mapping may identify one or more associations between a first set of time resources for DL communications using the first communication technology and a second set of time resources for DL communications using the second communication technology. Based on the resource mapping, the UE 115 may determine a timing for receiving a message from a network device associated with the second communication technology (e.g., VLC). In some cases, the network devices may perform feedback and retransmissions processes to avoid backhaul delay between the base station 105 and the network device associated with the second communication technology. In some cases, the UE 115 may measure a timing drift between resources for the first communication technology and resources for the second communication technology. In response, one or more network devices may reset (e.g., update, align) the resource mapping to correct for the timing drift.

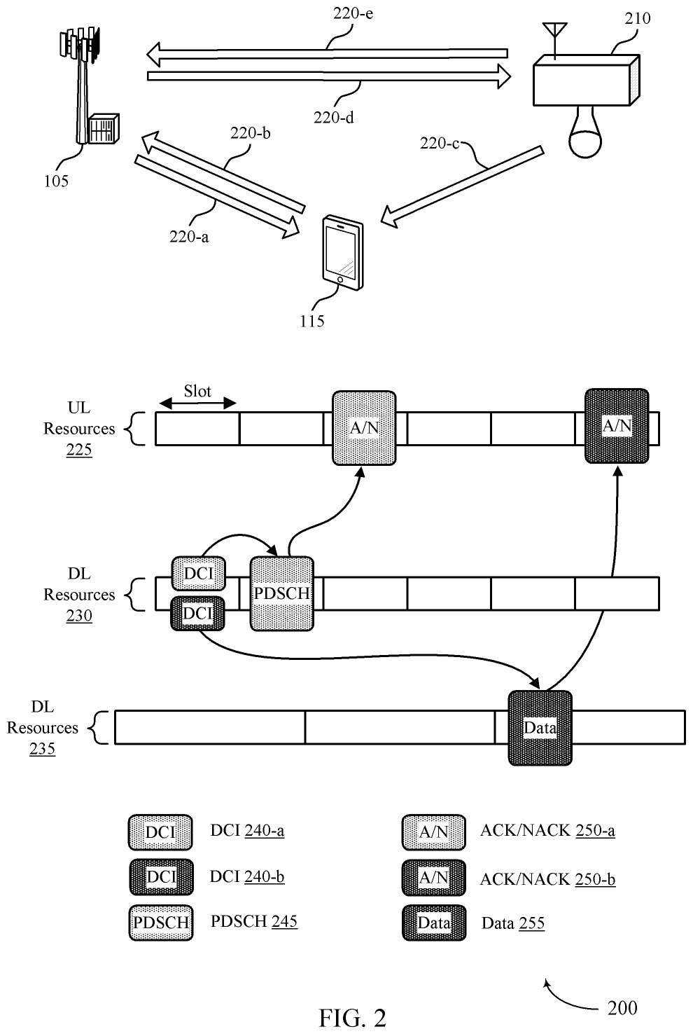

FIG. 2 illustrates an example of a wireless communications system 200 that supports inter-communication technology aggregation of asynchronous radio frequency and visible light communication links in accordance with aspects of the present disclosure. The wireless communications system 200 may implement aspects of the wireless communications system 100. For example, the wireless communications system 200 may include a base station 105 and a UE 115 which may be examples of corresponding base stations 105 and UEs 115 as described with reference to FIG. 1. In some cases, the base station 105 and the UE 115 may communicate over communication links 220, which may be examples of communication links 125 as described with reference to FIG. 1. In some cases, the communication link 220-e and the communication link 220-d may be examples of backhaul links. The wireless communication system 200 may additionally communicate with one or more network devices 210 that use a second communication technology different than a first communication technology used by the base station 105. As described herein, the UE 115 and the base station 105 may communicate using one or more of UL resources 225 associated with the base station 105 (and the first communication technology) and one or more DL resources 230. Similarly, the network device 210 and the UE 115 may communicate using one or more DL resources 235 associated with the network devices 210 (and the second communication technology).

The wireless communications system 200 may support multiple communication technologies. For example, the wireless communications system 200 may include the UE 115 and the base station 105, which may both be configured for communications using a first communication technology. Examples of the first communication technology may include any radio access technology, such as 5G, 4G, 3G, 2G, Wifi, Bluetooth, others, or any combination thereof. The first communication technology may support communications (e.g., wireless communications) using RF waves. For example, the base station 105 may transmit information to the UE 115 using RF-based communications. The wireless communication system 200 may additionally or alternatively include the network devices configured for communications using a second communication technology different than the first communication technology. In some examples, the second communication technology may be an example of a visible light communication technology, such as VLC. In such examples, the UE 115 or any other network device may additionally be configured for and support communications using one or more VLC technologies. The VLC technology may support communications (e.g., wireless communications) using visible light (e.g., light waves). For example, the network device 210 may transmit information to the UE 115 using visible light. In some cases, the second communication technology may be any communication technology different than the first communication technology and may include radio access technologies different than a radio access technology used by the base station 105. In such cases, examples of the second communication technology may include 5G, 4G, 3G, 2G, Wifi, Bluetooth, others, or any combination thereof.

For VLC technologies, one or more network devices may communicate with one or more other network devices using visible light. For example, the network device 210 (which may be an example of a VLC AP) may transmit data using a light emitting diode (LED) that varies in intensity faster than a human eye can perceive or detect. In some cases, a network device configured for communications using one or more VLC technologies may include a transmitting component, such as an LED, and a receiving component, such as a detector (e.g., a photo detector). For example, the network device 210 may include an LED and a photo detector. In some cases, the network device 210 may additionally include one or more receiving components, such as one or more antennas, for receiving RF-based communications. In some cases, a photo detector may detect light and generate one or more electrical signals based on detecting the light. The one or more electrical signals may include data (e.g., one or more messages) and noise. In some cases, a photo detector may be a photo-diode (PD) or an image sensor (IS). In some cases, the UE 115 may include a video component, such as a camera, which may include an IS.

In general, a VLC device (e.g., a network device configured for VLCs) may include electrical and optical components. For example, a VLC device may include one or more transmitters. A transmitter of a VLC device may include a modulator and an LED. Additionally, a VLC device may include one or more receivers. A receiver may include a photo detector and a demodulator. In some cases, a first VLC device may modulate data and transmit the modulated data over an optical channel using an LED. A second VLC device may receive the modulated data using a photo detector. A demodulation component of the second VLC device may demodulate the received data. In some cases, the UE 115 may be an example of a VLC device. For example, the UE 115 may receive information in the form of visible light using a photo detector, such as a PD or an IS. In some cases, the network device 210 may be an example of a VLC device. For example, the network device 210 may transmit information using visible light.

In some cases, one or more network devices associated with the wireless communications system 200 may be located indoors. For example, the network device 210 and the UE 115 may be located indoors. In some cases, one or more network devices may not be configured to utilize VLCs in outdoor environments. For example, a photo detector of a network device may be subject to interference from a variety of light sources in outdoor environments. As a result, a network device or a UE may be unable to successfully demodulate (e.g., decode) communication from other network devices using the second communication technology (e.g., VLC) in response to operating in an outdoor environment. In some cases, interference associated with indoor environments may be less than interference associated with outdoor environments. Additionally or alternatively, one or more network devices located indoors may be stationary, which may prevent or reduce alignment issues associated with visible light communications. For example, a network device configured for visible light communications may perform one or more alignment operations to position a photo detector at a location and an orientation where visible light communications may be received.

In some cases, transmitting communications using visible light may result in increased power consumption when compared to transmitting RF-based communications. For example, one or more LEDs used for transmitting communications using visible light may consume a significant amount of power when compared to RF-based communication transmission components. As a result, the UE 115 may not be configured for transmitting communications using visible light. In some cases, the UE 115 may include one or more components, which may be capable of transmitting communications using visible light, however, due to the power consumption associated with such components, the UE 115 may not be configured for, or may otherwise avoid transmitting VLCs. As described herein, the UE 115 may receive downlink communications using visible light from the network device 210. However, the UE 115 may not be configured to transmit uplink communications using visible light to the network device 210.

As described herein, the UE 115 may receive downlink communications using visible light from the network device 210, but may not transmit uplink communications using visible light to the network device 210. In some cases, the UE 115 may not transmit uplink communications using visible light based on a configuration, based on a capability of the UE 115, or based on a capability of the network device 210. For example, the UE 115 may not be configured for transmitting communications using visible light, the network device 210 may not be configured to receive uplink communications from the UE 115, the network device 210 may not be capable of receiving uplink communications from the UE 115, or any combination thereof. However, the UE 115 may have information for the network device 210. For example, the UE 115 may have feedback information associated with receiving the downlink communications using visible light from the network device 210.

In some cases, if the UE 115 has feedback for the network device 210, or any other case where the UE 115 has information for the network device 210, the UE 115 may relay information to the network device 210 via the base station 105. For example, the UE 115 may transmit feedback information, to the base station 105, associated with receiving or not receiving a DL message from the network device 210 and the base station 105 may retransmit the feedback information to the network device 210. In some cases, the base station 105 may retransmit the feedback information to the network device 210 via a backhaul link, such as the communication link 220-d. However, a delay (e.g., a backhaul delay) may be associated with the base station 105 transmitting the feedback information to the network device 210. Additionally or alternatively, one or more resources (e.g., one or more VLC DL resources 235) for communicating messages using the second communication technology (e.g., VLC) may not be synchronized with one or more resources (e.g., one or more UL resources 225 for the first communication technology, one or more DL resources 230 for the first communication technology) for RF-based communications. As a result, the network devices (e.g., the network device 210, the UE 115, and the base station 105) may be unable to successfully communicate.

In addition to communication challenges associated with one or more feedback processes, and more generally, one or more network devices within the wireless communications system 200 may be less effective at communicating using multiple communication technologies as compared with using a single technology. For example, the time-based resources for the communication link 220-b may not be synchronized with the time-based resources for the communication link 220-c. Similarly, the communication link 220-a may not be synchronized with the communication link 220-c, the communication link 220-e may not be synchronized with the communication link 220-c, and the communication link 220-d may not be synchronized with the communication link 220-c. In some cases, the communication links 220 may not be synchronized (in the time domain) due to the usage of separate oscillators and non-collocated deployment.

In some cases, a timing requirement for synchronized communications may not be satisfied between the two different communication technologies. For example, one or more communication frameworks may allow for a maximum timing difference of 33 microseconds (μs) between time-frequency resources. In some cases, one or more of the UL resources 225 may not be aligned with (e.g., synchronized with) one or more of the DL resources 235 for the second communication technology (e.g., VLC). Similarly, one or more of the DL resources 230 may not be aligned with (e.g., synchronized with) one or more of the DL resources 235. In some cases, the lack of synchronization between resources for different communication technologies may result in scheduling issues and may otherwise impair communications between network devices.

In accordance with the techniques described herein, network devices may synchronize communication timing for communications using different communication technologies (e.g., RATs and VLC technologies). For example, the UE 115 and the network device 210 may receive, from the base station 105, an indication of a resource mapping between resources for the first communication technology (e.g., the RF-based communications) and resources for the second communication technology (e.g., VLC). Additionally or alternatively, the UE 115 and the network device 210 may receive an indication of a delay associated with messages communicated using the second communication technology. The UE 115, the base station 105, and the network device 210 may communicate according to the resource mapping.

In some cases, the network (e.g., the base station 105) may synchronize timing for the first communication technology (e.g., RF-based communications) and the second communication technology (e.g., VLC) by configuring the communication link 220-c (e.g., the VLC link) as a supplemental downlink carrier for data transmissions. For example, the base station 105 may transmit information to the network device 210, intended for the UE 115. Accordingly, the network device 210 may receive the information from the base station 105 and may transmit a message to the UE 115, including the information. In some cases, one or more network devices may perform aggregation of RF-based communications and light-based communications on the physical layer with a single MAC layer and a single HARQ entity implemented by the first communication technology. In some cases, the MAC layer of the first communication technology may schedule one or more downlink transmissions to be transmitted using the communication link 220-c and the physical layer the first communication technology and the communication link 220-a and the physical layer of the second communication technology.

In some cases, retransmissions of the one or more downlink transmissions may be performed using the communication link 220-c or the communication link 220-a. For example, the network device 210 may transmit one or more downlink communications using the communication link 220-c. The UE 115 may not receive the one or more downlink communications and may transmit a negative acknowledgement (NACK) message to the base station 105. In some cases, the base station 105 may transmit one or more retransmissions of the one or more downlink communications to the UE 115 using the first communication technology. In some other cases, the network device 210 may transmit one or more retransmissions of the one or more downlink communications to the UE 115.

In some cases, the UE 115 may transmit information to the base station 105 via the communication link 220-b using one or more UL resources 225. The UL resources 225 may include multiple slots. In some cases, the base station 105 may transmit information to the UE 115 via the communication link 220-a using one or more DL resources 230. In some cases, the one or more UL resources 225 may be synchronized with the one or more DL resources 230 (e.g., a mapping is used to correlate DL communications with feedback information included in UL resources). In some cases, the network device 210 may transmit information to the UE 115 via the communication link 220-c using one or more DL resources 235. The one or more UL resources 225, DL resources 230, and DL resources 235 may be examples of time-frequency resources. However, in some cases, the DL resources 235 may not be synchronized with the DL resources 230 or the UL resources 225.

In accordance with the techniques described herein, the base station 105 may transmit control signaling to the UE 115 and the network device 210. For example, the base station 105 may transmit downlink control information (DCI) 240-a to the UE 115 using a DL resource 230. The base station 105 may transmit the DCI 240-a using RF-based communications. The DCI 240-a may include scheduling information such as an indication of a resource for a physical downlink shared channel (PDSCH) 245. Accordingly, the UE 115 may receive the DCI 240-a and may determine the PDSCH 245 scheduled to include information based on receiving the DCI 240-a. Additionally, the UE 115 may receive a message on the PDSCH 245 based on receiving the indication of the PDSCH 245. In some cases, the UE 115 may transmit feedback information such as an acknowledgement (ACK) or NACK 250-a to the base station 105 using a UL resource 225. Additionally or alternatively, the UE 115 may receive, from the base station 105, a DCI 240-b. The UE 115 may receive the DCI 240-b using a same DL resource 230 as the DCI 240-a. For example, the UE 115 may receive the DCI 240-a and the DCI 240-b simultaneously.

In some cases, the DCI 240-b may include scheduling information such as an indication of a resource for data 255. Accordingly, the UE 115 may receive the DCI 240-b and may determine a DL resource 235 for receiving the data 255. In some cases, the DCI 240-b may include a delay (e.g., the delay may account for a backhaul delay between the base station 105 and the network device 210). For example, the DCI 240-b may indicate a delay associated with receiving the data 255. In some cases, the UE 115 may receive the indication of the delay and determine the DL resource 235 for receiving the data 255 based on receiving the indication of the delay. In some cases, the network device 210 may transmit the data 255 to the UE 115 using VLCs. In some cases, the UE 115 may receive the data 255 and transmit feedback to the base station 105 using RF-based communications. For example, the UE 115 may transmit feedback information such as an ACK/NACK 250-b to the base station 105 using a UL resource 225.

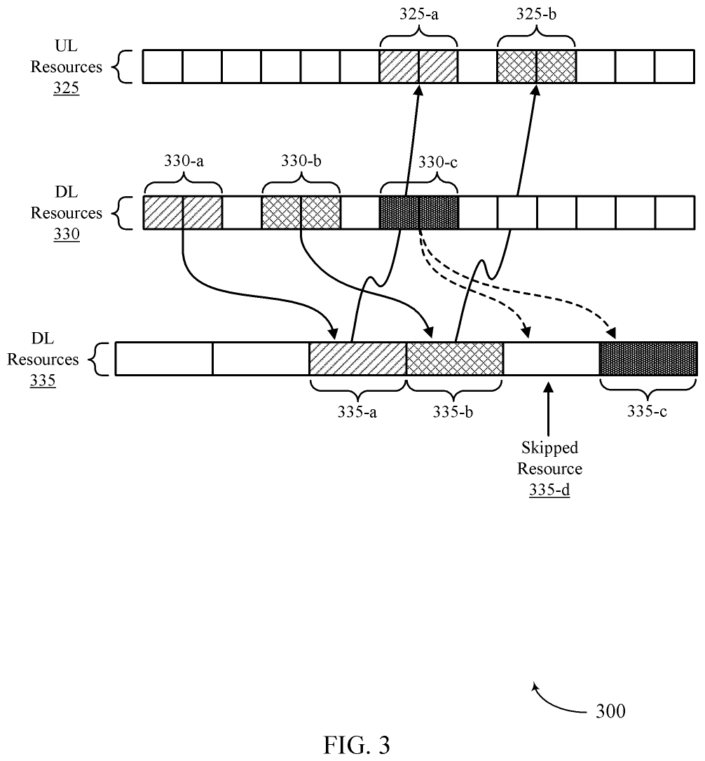

FIG. 3 illustrates an example of communication resources 300 that support inter-communication technology aggregation of asynchronous radio frequency and visible light communication links in accordance with aspects of the present disclosure. The communication resources 300 may be implemented by aspects of the wireless communications system 100. For example, the communication resources 300 may include UL resources 325 for a first communication technology, DL resources 330 for the first communication technology (e.g., a RAT), and DL resources 335 of a second communication technology (e.g., VLC), which may be examples of corresponding UL resources 225, DL resources 230, and DL resources 235 as described with reference to FIG. 2. In some cases, the UE 115 and the base station 105 as described with reference to FIG. 2 may communicate using one or more of the UL resources 325 and one or more of the DL resources 330 of the first communication technology (e.g., a RAT such as 5G or 4G). Similarly, the network device 210 and the UE 115 as described with reference to FIG. 2 may communicate using one or more of the DL resources 335 of the second communication technology (e.g., VLC or RAT different than the first communication technology).

The communication resources 300 may be associated with one or more network devices. For example, a base station 105 may transmit information to a UE 115 using one or more of the DL resources 330, the UE 115 may transmit information to the base station 105 using one or more of the UL resources 325, and a network device 210 may transmit information to the UE 115 using one or more of the DL resources 335. In some cases, the DL resources 335 may not be synchronized with the UL resources 325 or the DL resources 330, which may result in timing issues.

In accordance with the techniques described herein, network devices may synchronize communication timing for communications using different communication technologies. For example, the base station 105 may transmit, to the UE 115 and the network device 210, control signaling indicating a resource mapping. The indication may include a resource mapping between resources associated with a first communication technology (e.g., a RAT) and a second communication technology (e.g., a VLC technology). For example, the indication may indicate that the DL resources 330-a are mapped to the DL resources 335-a and the UL resources 325-a.

The UE 115 may determine a slot or a frame for receiving DL transmissions from the network device 210 based on receiving the indication of the resource mapping. For example, the UE 115 may receive control signaling from the base station 105 using one or more of the DL resources 330-a. In some cases, the control signaling may include the indication of the resource mapping. Based on the resource mapping, the UE 115 may determine a timing associated with a DL transmission from the network device 210. For example, the UE 115 may determine a timing associated with receiving a DL transmission using the DL resources 335-a. The UE 115 may use the mapping to match resources indicated as scheduled by control signaling transmitted over the DL resources 330 with the data transmissions over the DL resources 335. Because some control signaling occurs using the first communication technology and some data signaling occurs using both the first communication technology and the second communication technology, the UE may use the mapping to determine correlations between resources of different communication technologies. Additionally or alternatively, the UE 115 may determine to use UL resources 325-a to transmit feedback to the base station 105 for transmissions received using the DL resources 335. For example, the UE 115 may transmit, using the UL resources 325-a, an ACK to the base station 105 based on receiving the DL transmission using the DL resources 335-a.

The resource mapping may indicate a mapping between multiple resources. In some cases, the resource mapping may indicate that the DL resources 330-a are mapped to the DL resources 335-a. For example, a base station 105 may use control signaling over the DL resources 330 to schedule data transmissions over both the DL resources 330 for the first communication technology and the DL resources 335 of the second communication technology. In such examples, a mapping between the different DL resources may enable a UE 115 or base station 105 to determine what DL resources 335 of the second communication technology are being scheduled by control signaling over the DL resources 330. In some cases, the DL resources 335-a are mapped to the UL resources 325-a. For example, feedback information may be associated with the DL transmission that uses the DL resources 335-a, but that feedback information may be transmitted using the UL resources 325 of the first communication technology. In such examples, a mapping between DL resources 335 of the second communication technology and the UL resources 325 of the first communication technology may enable a UE 115 or base station 105 to determine what UL resources 325 of the first communication technology are used to transmit feedback information for the DL transmissions over the DL resources 335 of the second communication technology. Similarly, the resource mapping may indicate that the DL resources 330-b are mapped to the DL resources 335-b, and the DL resources 335-b are mapped to the UL resources 325-b. Additionally or alternatively, the resource mapping may indicate that the DL resources 330-c are mapped to the DL resources 335-c, and the DL resources 335-c are mapped to UL resources 325, which are not shown.

In some cases, the resource mapping may indicate one or more system frame numbers, one or more frame offsets, one or more slot durations, one or more frame lengths (or durations), or any combination thereof. The size and duration of time resources for the different communication technologies may be different. Thus, the mapping may provide indications of identifiers of different time resources (e.g., frames or slots), durations of the different time resources, offsets between the different time resources, parameters relating to timing drift between the different resources, or combination thereof. Accordingly, the UE 115 and the network device 210 may determine a mapping between one or more resources implicitly. For example, the UE 115 and the network device 210 may determine the mapping based on the one or more system frame numbers, one or more frame offsets, one or more slot durations, one or more frame lengths, or any combination thereof.

One or more resources for RF-based communications may be offset from one or more resources for VLCs. For example, one or more UL resources 325 or one or more DL resources 330 may be offset from one or more DL resources 335 because different durations of frames are used or starting positions of frames are different or both. In some cases, the UE 115 or the base station 105 may determine an offset between a resource associated with RF-based communications and a resource associated with VLCs. For example, the UE 115 or the base station 105 may determine a first time offset between a first DL resource 330 and a first DL resource 335. In some cases, the UE 115 may determine a second time offset between a second DL resource 330 and a second DL resource 335. In some cases, the difference between the second time offset and the first time offset may represent a timing drift between the resources.

In some cases, the UE 115 or the base station 105 may determine that the timing drift between the time resources of the different communication technologies is greater than or equal to a threshold timing drift. In some cases, if the UE 115 determines that the timing drift is greater than or equal to the threshold timing drift, the UE 115 may transmit an indication of the timing drift to the base station 105. Accordingly, the UE 115 or the base station 105 may adjust the resource mapping based on the timing drifting being greater than or equal to the threshold. For example, an initial resource mapping may indicate that the DL resource 330-c is mapped to the skipped resource 335-d. However, the skipped resource 335-d may not correspond to a DL transmission as a result of the timing drift. In some cases, the UE 115 or the base station 105 may adjust the resource mapping so that the DL resource 330-c is mapped to the DL resource 335-c.

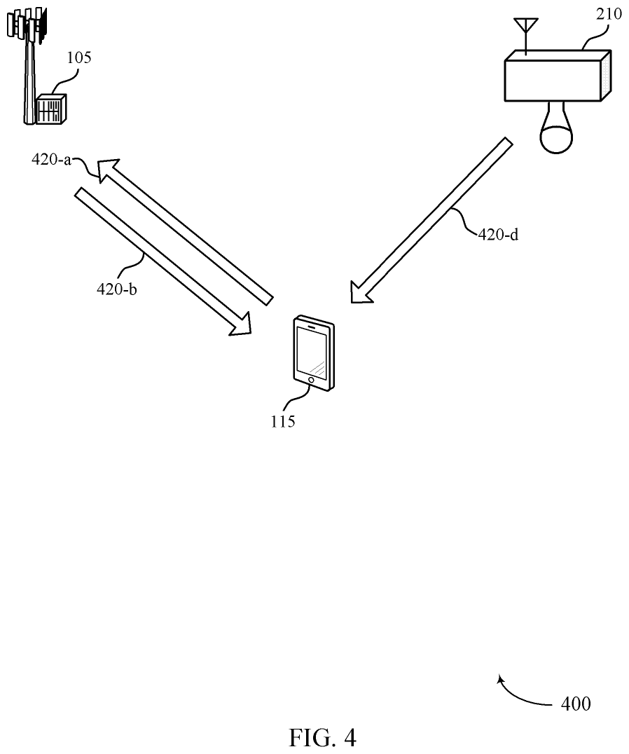

FIG. 4 illustrates an example of a wireless communications system 400 that supports inter-communication technology aggregation of asynchronous radio frequency and visible light communication links in accordance with aspects of the present disclosure. The wireless communications system 400 may implement aspects of the wireless communications system 100 and the wireless communications system 200. For example, the wireless communications system 400 may include a base station 105 and a UE 115 which may be examples of corresponding base stations 105 and UEs 115 as described with reference to FIG. 1 and FIG. 2. Additionally, the wireless communications system 400 may include a network device 210, which may be an example of a corresponding network device 210 as described with reference to FIG. 2. In some cases, the base station 105 and the UE 115 may communicate over communication link 420-a (e.g., uplink communications using the first communication technology) and communication link 420-b (e.g., downlink communications using the first communication technology), which may be examples of communication links 125 as described with reference to FIG. 1, and communication link 220-a and communication link 220-b, as described with reference to FIG. 2. Additionally or alternatively, the UE 115 and the network device 210 may communicate over communication link 420-d, which may be an example of communication link 220-c as described with reference to FIG. 2.

The UE 115 may transmit one or more feedback messages to the base station 105. In some cases, the UE 115 may transmit one or more feedback messages associated with receiving or not receiving communications from the network device 210. For example, the UE 115 may not be configured for transmitting feedback information to the network device 210 based on a capability of the UE 115. In some cases, the UE 115 may not be capable of effectively or efficiently transmitting uplink communications to the network device 210 (e.g., transmitting uplink communications using VLCs or other access technology). For example, transmitting uplink communications to the network device 210 using VLCs may consume a large amount of power at the UE 115. In other cases, alignment issues or interference from other light sources may prevent the UE 115 from transmitting uplink communications to the network device 210. As a result, the UE 115 may transmit, to the base station 105, one or more feedback messages associated with receiving downlink communications from the network device 210. Features of uplink communications in VLC technologies are described as an example. In examples where a different type of communication technology is used as the second communication technology (e.g., a RAT), these features may apply to any communication link that is used for downlink only and uplink communication may not be available.

The UE 115 may additionally or alternatively transmit one or more feedback messages to the base station 105 (e.g., using the first communication technology) that are not associated with the network device 210. For example, the base station 105 and the UE 115 may communicate using RF-based communications. In some cases, the base station 105 may transmit one or more downlink messages to the UE 115 and the UE 115 may transmit one or more uplink feedback messages to the base station 105 based on receiving or not receiving the one or more downlink messages.

The UE 115 and the base station 105 may communicate using multiple component carriers over various communication links 420. For example, the UE 115 and the base station 105 may establish communication link 420-a and communication link 420-b. In some cases, the UE 115 may communicate feedback information associated with receiving messages from the network device 210 using a first component carrier of the communication link 420-a. Similarly, the UE 115 may communicate feedback information associated with receiving messages from the base station 105 using a second component carrier of the communication link 420-a. That is, the UE 115 may transmit feedback information to the base station 105 using different components carriers based on an association between the network device and the feedback information. In some cases, the first component carrier of the communication link 420-a and the second component carrier of the communication link 420-a may be on a same frequency band or different frequency bands. Additionally or alternatively, the first component carrier of the communication link 420-a and the second component carrier of the communication link 420-a may have different physical resource block (PRB) resources.

The UE 115 and the base station 105 may be capable of transmitting and receiving communications simultaneously. For example, the UE 115 may have a dual transmission capability, which may enable the UE 115 to simultaneously transmit multiple feedback messages using one or more antenna components. Similarly, the base station 105 may be capable of simultaneously receiving multiple feedback messages using one or more antenna components. In some cases, transmitting or receiving multiple messages simultaneously may be referred to as dual transmission. In some cases, the UE 115 may be capable of full-duplex communications.

In some cases, if the UE 115 has a dual transmission capability, the UE 115 may transmit multiple feedback messages to the base station simultaneously. For example, the UE 115 may simultaneously transmit a first feedback message to the base station using the communication link 420-a and a second feedback message using the communication link 420-a. The first feedback message may be associated with downlink communications from the network device 210. The second feedback message may be associated with downlink communications from the base station 105. In such cases, the UE 115 may transmit the first feedback message using a first frequency band and the second feedback message using a second frequency band. In some cases, the base station 105 may assign one or more non-overlapping, dedicated PRB resources to the communication link 420-a, which may be associated with feedback for one or more VLC messages.

In some cases, if the UE 115 is not capable of dual transmission, the UE 115 may not transmit multiple feedback messages associated with receiving messages from the base station 105 and the network device 210 simultaneously. Alternatively, the UE 115 may transmit multiple feedback messages associated with receiving messages from the base station 105 and the network device 210 using time-division multiplexing. For example, the UE 115 may time-division multiplex one or more feedback messages associated with the downlink communications from the network device 210 with one or more feedback messages associated with downlink communications from the base station 105. In such cases, the UE 115 may transmit feedback messages to the base station 105 using the first communication link 420-a.

In some examples, the base station 105 may be configured as a master node and the network device may be configured as a secondary node. In some cases, the base station 105 may configure the UE 115 and the network device 210 via radio resource control (RRC) signaling. In some cases, the network may support user plane aggregation, control-data plane separation, and uplink/downlink separation, which may be associated with concepts similar to dual connectivity. In some cases, if the UE 115 is not capable of full duplex communications, the UE 115 may time-division multiplex one or more feedback messages based on a time domain pattern (e.g., a preconfigured pattern). In some cases, the time domain pattern may be reset to address a timing drift between resources associated with second communication technology (e.g., VLC) and resources associated with the first communication technology (e.g., RF-based communications).

In some cases, if the UE 115 has a dual transmission capability, the UE 115 and the base station 105 may perform power control interaction. For example, UE 115 may split power semi-statically between multiple uplink carriers. In some cases, the UE 115 may split power between the uplink carriers associated with feedback information for DL transmissions communicated using the first communication technology and the uplink carriers associated with feedback information for DL transmissions communicated using the second communication technology. In some other cases, the UE 115 may perform dynamic power sharing for different uplink carriers when the power for transmitting feedback information (and other uplink information) exceeds a power limit. For example, the UE 115 may be configured to operate according to a power limit. The UE 115 may adjust (e.g., scale) power associated with different carriers based on if the power limit is exceeded.

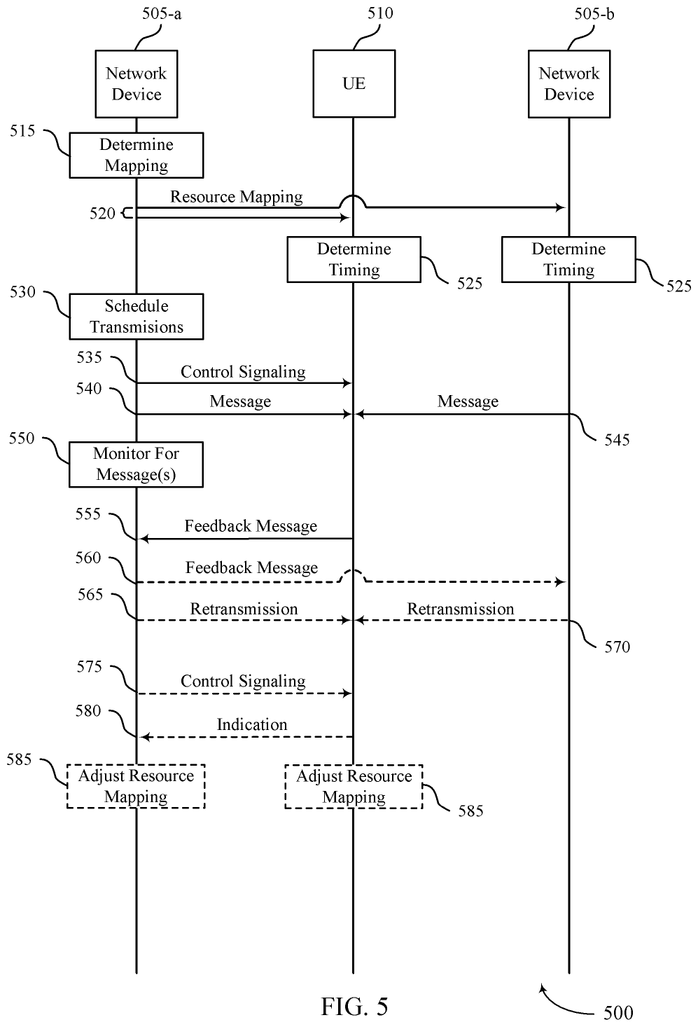

FIG. 5 illustrates an example of a process flow 500 that supports inter-communication technology aggregation of asynchronous radio frequency and visible light communication links in accordance with aspects of the present disclosure. In some examples, process flow 500 may implement aspects of the wireless communications systems 100 and 200. For example, process flow 500 may include UE 510, which may be an example of corresponding UEs 115 as described with reference to FIGS. 1 and 2. Process flow 500 may also include a first network device 505-a that uses a first communication technology (e.g., a RAT such as 5G or 4G), which may be an example of corresponding base stations 105, as described with reference to FIGS. 1 and 2. Process flow 500 may additionally include a second network device 505-b that uses a second communication technology (e.g., VLC or another RAT), which may be an example of a corresponding network device 210, as described with reference to FIG. 2.

In the following description of process flow 500, the operations between the UE 510, the first network device 505-a, and the second network device 505-b may be transmitted in a different order than the order shown, or the operations may be performed at different times. Some operations may also be left out of process flow 500, or other operations may be added to process flow 500. While UE 510 is shown performing a number of the operations of process flow 500, any wireless device may perform the operations shown. For example, first network device 505-a and second network device 505-b may perform the operations shown.

Communications that are based on radio frequencies may face challenges due to limited spectrum for carrier frequencies. It may be desirable to combine communication technologies that leverage different portions of the RF spectrum to increase a throughput of communications. It may also be desirable to use alternatives to RF-based communication, such as visible light communication, using VLC technology. In VLC technology, an emitter may modulate an intensity or frequency of transmitted light to encode visible light with information. A receiver may use a photo-detector to detect the light and decode the information encoded in the visible light. VLC technology may be used with fiber optic cables and other medium and it may also be used as a wireless communication technique. A UE 510 (such as a smartphone) may be configurable to use one or more antennas for RF-based communication and one or more cameras and light emitting devices for visible light based communication.

Combining different communication technologies (such as an RF-based technology and a visible light technology) may increase a throughput data that is capable of being communicated to the UE 510. Different communication technologies may not be synchronized with one another. For example, timing for an RF-based technology may be asynchronous with timing for a VLC technology. Such situations may be due to using different components such as oscillators, disparate deployments, different standardized timings, and other factors. In some cases, VLC deployments may be more effective at communicating DL information than communicating UL information. For example, a UE 510 may be able to decode visible light transmitted by a VLC AP, but (due to power constraints, misalignment, among other factors), the UE 510 may be less able to transmit visible light to the VLC AP. In such examples, it may be desirable to provide a separate uplink connection for a VLC deployment. Techniques for inter-communication technology aggregation between asynchronous communication technologies is described.

At 515, the first network device 505-a may determine a resource mapping between a first set of time resources of a first communication technology and second set of time resources of a second communication technology. In some cases, the first set of time resources may include one or more slots, one or more frames, or any combination thereof. Similarly, the second set of time resources may include one or more slots, one or more frames, or any combination thereof. The resource mapping may include a first mapping between DL resources of the first communication technology and DL resources of the second communication technology and a second mapping between DL resources of the second communication technology and UL resources of the first communication technology. The first mapping may be useful to coordinate scheduling for resources through a single network device (either the first network device 505-a or the second network device 505-b). The second mapping may be useful to coordinate transmitting feedback information about the second communication technology through UL resources of the first communication technology.

At 520, the first network device 505-a may transmit to the UE 510 and the second network device 505-b an indication of a resource mapping between a first set of time resources of the first communication technology and a second set of time resources of a second communication technology. The first network device 505-a may be configured as an example of a master node that controls scheduling for between the UE 510 and both the first network device 505-a and the second network device 505-b. In some examples, the master node may be responsible for access control plane handling and RRC-based configuration of the devices. In such configurations, user plane aggregation, control-data plane separation or uplink-downlink separation can be supported for connectivity that uses both the first communication technology (e.g., 5G) and the second communication technology (e.g., VLC).

The communication link between the first network device 505-a and the UE 510 may use the first communication technology (e.g., a RF-based technology such as 5G or 4G). Receiving the indication may include receiving, an indication of the first mapping or the second mapping or both.

In some cases, receiving the indication may include receiving, an indication that the second set of time resources for downlink communications using the second communication technology is mapped to a third set of time resources for uplink communications using the first communication technology, and transmitting, to the first network device 505-a, a second message using the first communication technology based on receiving the indication. In some cases, the second message may include feedback information associated with the first message received from the second network device 505-b using the second communication technology.

In some cases, receiving the indication may include receiving specific information about the alignment between the time resources. In some examples, the alignment of time resources between the first communication technology and the second communication technology may be based on the system frame numbers of both technologies. In such examples, the indication may include one or more system frame numbers associated with the first communication technology or the second communication technology or both, one or more frame offsets between the first communication technology and the second communication technology, and one or more slot durations or lengths or frame durations or lengths associated with the first communication technology or the second communication technology or both, or any combination thereof. By knowing frame durations, an offset between a start time of a frame of the first communication technology and a start time of a frame of the second communication technology, and frame numbers, an alignment between the time resources of the two communication technologies may be determined. In some examples, receiving the indication may include determining a timing for receiving the first message using the second communication technology based on any combination of the one or more system frame numbers, the one or more frame offsets, and the one or more slot durations or frame lengths, where receiving a first message is based on determining the timing.

At 525, the UE 510 may determine a timing for receiving a first message from the second network device 505-b using the second communication technology based on the resource mapping. In such examples, the UE 510 may know from an indication of scheduled resources from the first network device 505-a which resources the second network device 505-b may use to transmit the scheduled information. Similarly, the second network device 505-b may determine a timing for transmitting, to the UE 510, the first message using the second communication technology based on the resource mapping. In some cases, the UE 510 may determine the timing based on receiving an indication that the first set of time resources for downlink communications using the first communication technology is mapped to the second set of time resources for downlink communications using the second communication technology.

In some cases, the UE 510 may determine the timing based on receiving one or more system frame numbers associated with the first communication technology or the second communication technology or both, one or more frame offsets between the first communication technology and the second communication technology, and one or more slot durations or frame lengths associated with the first communication technology or the second communication technology or both, or any combination thereof.

The UE 510 may align a timing associated with the first communication technology and a timing associated with the second communication technology. Similarly, the first network device 505-a may align a timing associated with the first communication technology and a timing associated with the second communication technology. In some cases, the resource mapping between the first set of time resources for downlink communications using the first communication technology and the second set of time resources for downlink communications using the second communication technology may be based on the aligning.

The UE 510 may determine one or more offsets between a time resource associated with the first communication technology and a time resource associated with the second communication technology. In some cases, the UE 510 may determine a first offset between a time resource associated with the first communication technology and a time resource associated with the second communication technology. For example, one or more time-frequency resources associated with the first communication technology may not be synchronized with one or more time-frequency resources associated with the second communication technology. In some cases, the UE 510 may determine an offset such as a time difference between a first frame associated with the first communication technology and a second frame associated with the second communication technology.

The UE 510 may determine a second offset between the time resource associated with the first communication technology and the time resource associated with the second communication technology. For example, the UE 510 may measure the first offset and may subsequently measure a second offset. The second offset may be different than the first offset because of timing drift between the two communication technologies. For example, if the two technologies use different frame lengths the offset between individual frames may change over time. In other examples, if the two technologies use different clock frequencies, the offset between individual frame may change over time. In some cases, the second offset may correspond to time resources associated with the first offset. In some other cases, the second offset may correspond to time resources not associated with the first offset.

The UE 510 may determine a difference between the first offset and the second offset corresponding to a timing drift between the first communication technology and the second communication technology. For example, the UE 510 may determine a timing drift associated with a lack of synchronization (e.g., different clock frequencies or different frame durations or lengths) between the first communication technology and the second communication technology. In some cases, the UE 510 may determine that the difference meets or exceeds a threshold difference. Similarly, the UE 510 may determine that the timing drift meets or exceeds a threshold timing drift.

At 535, the UE 510 may receive, from the first network device 505-a using the first communication technology, control signaling indicating resources that have been scheduled for communications with the UE 510. The scheduled resources may include DL resources for the first communication technology (e.g., transmitted by the first network device 505-a) and DL resources for the second communication technology (e.g., transmitted by the second network device 505-b). The first network device 505-a may be acting as an example of a master node that schedules and coordinates communications across both communication technologies. The first network device 505-a may transmit DCI to schedule the resources. In some cases, a starting position in a time domain for the scheduled resources may be indicated in terms of the first communication technology (e.g., a slot index parameter may indicate a slot offset between the slot in which the DCI is received and the slot in which a PDSCH message is received). In such examples, the UE 510 may identify an indication of DL resources of the second communication technology scheduled in the DCI and then may use the resource mapping to determine the precise DL resources of the second communication technology that may be used to transmit the data to the UE 510. For example, the UE 510 may convert or translate a slot of the first communication technology to a frame or slot of the second communication technology.

At 540, the UE 510 may receive, from the first network device 505-a, a first message using the first communication technology. The first message may have been scheduled by the control signaling at 535. At 545, the UE 510 may receive, from the second network device 505-b, a second message using the second communication technology. The second message may have been scheduled by the control signaling at 535. In some cases, the UE 510 may receive the second message based on adjusting the resource mapping. Additionally or alternatively, the UE 510 may receive the second message based on receiving, from the first network device 505-a, the indication of the resource mapping.

Aggregation of communication links using the first network device 505-a as an example of a master node may provide benefits and efficiencies. For example, the information being communication to the UE 510 may be scheduled with a single message. Additionally or alternatively, feedback from the UE 510 about the DL communications may be combined into a single entity.

In some examples, the network device that is acting as the master node (e.g., the first network device 505-a), may implement a single HARQ entity for DL communications over both the DL resources of the first communication technology and the DL resources of the second communication technology. In such examples, the first network device 505-a may organize the packets into one or more transport blocks (e.g. using the MAC layer) that include one or more synchronized HARQ identifiers. The first network device 505-a may send a first set of the transport blocks to the second network device 505-b to be transmitted to the UE 510 using the second communication technology. The first network device 505-a may also use its own PHY layer to transmit a second set of transport blocks to the UE 510 over a communication link of the first communication technology (e.g., over a RF-based air interface).

In some examples, the MAC layer of the first communication technology (via the first network device 505-a) may be responsible for scheduling DL transmission via both the first communication technology (e.g., message 540) and the second communication technology (e.g., message 545). In such examples, HARQ retransmissions may be handled by the MAC layer of the first communication technology (implemented by the first network device 505-a). In some cases, the UE 510 may not be configured to transmit UL messages to the second network device 505-b of the second communication technology. In such cases, the HARQ retransmissions for both the DL transmissions via the first communication technology (e.g., message 540) and the DL transmissions via the second communication technology (e.g., message 545) may be handled by the first network device 505-a.

The UE 510 may transmit HARQ feedback (e.g., feedback messages at 555) to the first network device 505-a for both the message 540 and the message 545. In some cases, the HARQ retransmissions may be transmitted using the communication technology that transmitted the original DL transmission. For example, the first network device 505-a, may transmit an indication of the HARQ feedback to the second network device 505-b and the second network device 505-b may transmit the retransmission for the message 545 (e.g., at 570). In some cases, the HARQ retransmissions can use a different communication technology than the original DL transmission. For example, the first network device 505-a may be able to send retransmission via the first communication technology for both the message 540 and the message 545 (e.g., at 565). Using the first network device 505-a to transmit HARQ retransmission for both message 540 and message 545 may have a reduced latency, as compared with having the second network device 505-b perform the retransmission. The increased time for the retransmissions may be due to the time it may take to perform messaging via backhaul link between the first network device 505-a and the second network device 505-b.

At 550, the first network device 505-a may monitor for one or more messages (e.g., feedback message at 555, such as HARQ feedback) from the UE 510 based on the resource mapping. For example, the first network device 505-a may activate one or more components associated with monitoring for messages. For example, the first network device 505-a may monitor for messages during one or more frames or slots associated with the first communication technology, the second communication technology, or both.

At 555, the UE 510 may transmit, to the first network device 505-a, a feedback message using the first communication technology based on receiving the message 540 from the first network device 505-a or the message 545 from the second network device 505-b or both. In some cases, the feedback message may include feedback information associated with the message 540 received from the first network device 505-a using the first communication technology, feedback information associated with the message 545 received from the second network device 505-b using the second communication technology, or both. In some cases, the feedback message may include feedback information associated with one or more HARQ processes. The feedback message may include an ACK or NACK about whether the messages were successfully decoded.

At 560, the first network device 505-a may transmit, via a backhaul connection, to the second network device 505-b, feedback information associated with the message 545 transmitted by the second network device 505-b based on receiving the second message from the UE 510. In some cases, the feedback message may include feedback information associated with the message 345 received from the second network device 505-b using the second communication technology. In some cases, the feedback message may include feedback information associated with one or more HARQ processes. The feedback message may include an ACK or NACK about whether the message 545 were successfully decoded. In some cases, the first network device 505-a may transmit, using the first communication technology, to the second network device 505-b, feedback information associated with the message 545 based on receiving the feedback message from the UE 510.

At 565, the UE 510 may receive, from the first network device 505-a, one or more retransmissions of the message 540, one or more retransmissions of the message 545, or both using the first communication technology. For example, the UE 510 may transmit a NACK to the first network device 505-a about either the message 540 or the message 545 or both. Based on receiving the NACK from the UE 510, the first network device 505-a may determine to transmit one or more retransmissions of the messages using the first communication technology.

In some cases, the first network device 505-a may be configured to transmit one or more retransmissions for messages transmitted via the first communication technology and messages transmitted via the second communication technology (e.g., at 565) to avoid a delay associated with relaying the feedback information to the second network device 505-b. In some cases, the first network device 505-a may be configured to transmit one or more retransmissions for messages transmitted via the first communication technology (e.g., at 565) and the second network device 505-b may be configured to transmit one or more retransmissions (e.g., at 570) for messages transmitted via the second communication technology. In such examples, the first network device 505-a may be configured to transmit feedback information (e.g., at 560) to the second network device 505-b.

In some cases, feedback messages associated with the first communication technology and the second communication technology may be transmitted over different UL carriers on the same the radio frequency bands. In such cases, the feedback messages (e.g., at 555) for the DL transmissions communicated via the first communication technology (e.g., message 540) may be transmitted over a first UL carrier on the first radio frequency band and the feedback messages (e.g., at 555) for the DL transmissions communicated via the second communication technology (e.g., message 545) may be transmitted over the second UL carrier on the first radio frequency band.

In some cases, feedback messages associated with the first communication technology and the second communication technology may be transmitted over different UL carriers on different radio frequency bands. In such cases, feedback messages (e.g., at 555) for the DL transmissions communicated via the first communication technology (e.g., message 540) may be transmitted over a first UL carrier on a first radio frequency band and feedback messages (e.g., at 555) for the DL transmissions communicated via the second communication technology (e.g., message 545) may be transmitted over a second UL carrier on a second radio frequency band. The feedback messages (e.g., at 555) may be transmitted using a time-division multiplexing pattern based on a single transmit capability of the UE 510. In some cases, the feedback messages (e.g., at 555) may be transmitted simultaneously based on a dual-transmit capability of the UE 510.

At 575, the UE 510 may receive, from the first network device 505-a using the first communication technology, control signaling indicating a delay associated with messages communicated using the second communication technology relative to the first communication technology.

At 580, the UE 510 may transmit an indication of the timing drift between the time resources of the first communication technology and the second communication technology to the first network device 505-a based on determining a differences between the time resources of the communication technologies. In some cases, the UE 510 may transmit an indication of the timing drift to the second network device 505-b. At 585, the UE 510 may adjust the resource mapping based on the timing drift satisfying a threshold. Additionally or alternatively, at 585 the first network device 505-a may adjust the resource mapping based on the timing drift satisfying the threshold.

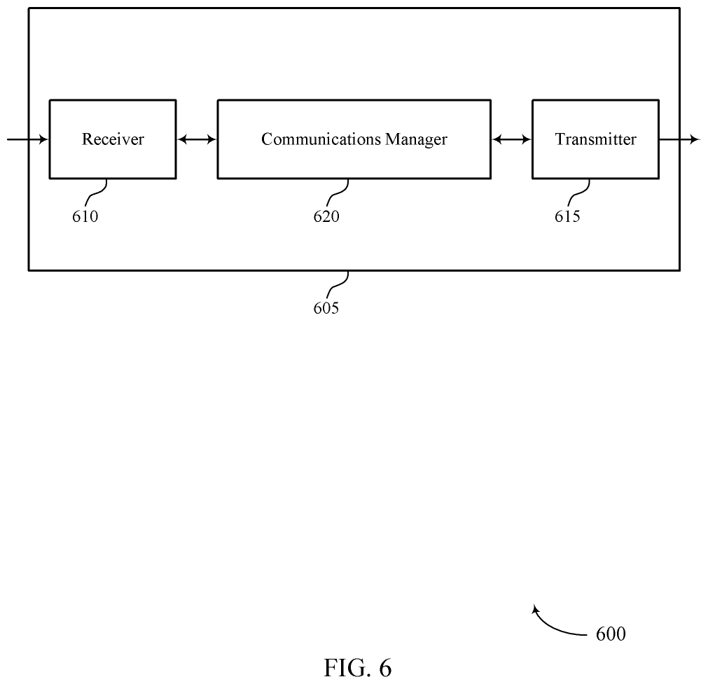

FIG. 6 shows a block diagram 600 of a device 605 that supports inter-communication technology aggregation of asynchronous radio frequency and visible light communication links in accordance with aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to inter-communication technology aggregation of asynchronous radio frequency and visible light communication links). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to inter-communication technology aggregation of asynchronous radio frequency and visible light communication links). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of inter-communication technology aggregation of asynchronous radio frequency and visible light communication links as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 620 may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a UE in accordance with examples as disclosed herein. For example, the communications manager 620 may be configured as or otherwise support a means for receiving, from a first network device using a first communication technology, an indication of a resource mapping between a first set of time resources for downlink communications using the first communication technology and a second set of time resources for downlink communications using a second communication technology. The communications manager 620 may be configured as or otherwise support a means for determining a timing for receiving a first message from a second network device using the second communication technology based on receiving the indication of the resource mapping. The communications manager 620 may be configured as or otherwise support a means for receiving, from the second network device, the first message using the second communication technology based on determining the timing.

By including or configuring the communications manager 620 in accordance with examples as described herein, the device 605 (e.g., a processor controlling or otherwise coupled to the receiver 610, the transmitter 615, the communications manager 620, or a combination thereof) may support techniques for synchronized communications between network devices using different communication technologies, which may reduce processing, reduce power consumption, and lead to more efficient utilization of communication resources. For example, the device 605 may support reduced processing associated with one or more feedback processes. The techniques for reduced processing may allow the device 605 to reduce the processing overhead at the device 605 and more efficiently perform feedback message signaling or retransmission signaling. Accordingly, more efficiently performing feedback message signaling may reduce power consumption at the device 605.

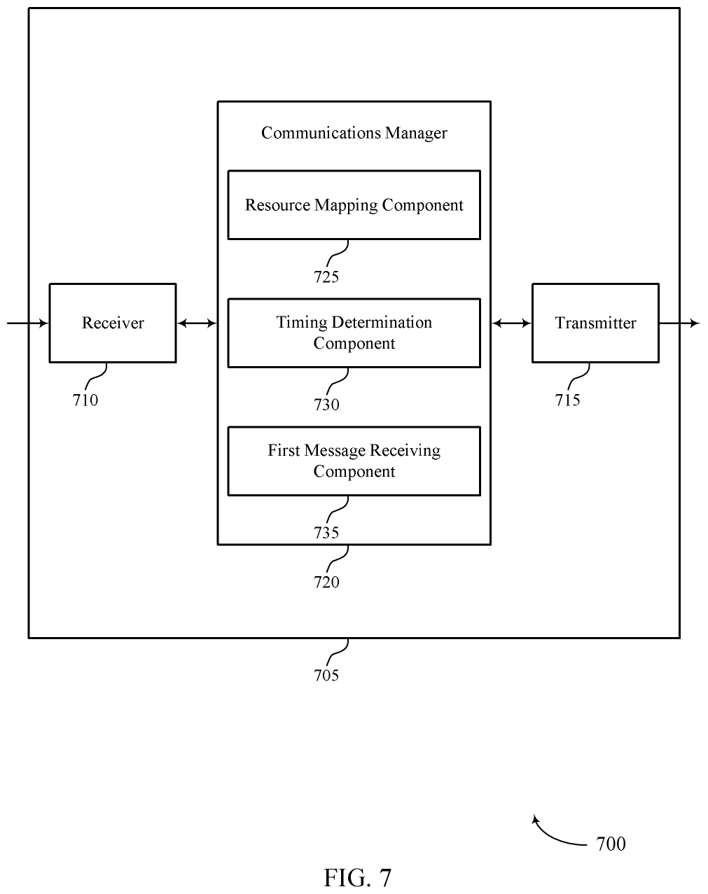

FIG. 7 shows a block diagram 700 of a device 705 that supports inter-communication technology aggregation of asynchronous radio frequency and visible light communication links in accordance with aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to inter-communication technology aggregation of asynchronous radio frequency and visible light communication links). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to inter-communication technology aggregation of asynchronous radio frequency and visible light communication links). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of inter-communication technology aggregation of asynchronous radio frequency and visible light communication links as described herein. For example, the communications manager 720 may include a resource mapping component 725, a timing determination component 730, a first message receiving component 735, or any combination thereof. The communications manager 720 may be an example of aspects of a communications manager 620 as described herein. In some examples, the communications manager 720, or various components thereof, may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communication at a UE in accordance with examples as disclosed herein. The resource mapping component 725 may be configured as or otherwise support a means for receiving, from a first network device using a first communication technology, an indication of a resource mapping between a first set of time resources for downlink communications using the first communication technology and a second set of time resources for downlink communications using a second communication technology. The timing determination component 730 may be configured as or otherwise support a means for determining a timing for receiving a first message from a second network device using the second communication technology based on receiving the indication of the resource mapping. The first message receiving component 735 may be configured as or otherwise support a means for receiving, from the second network device, the first message using the second communication technology based on determining the timing.

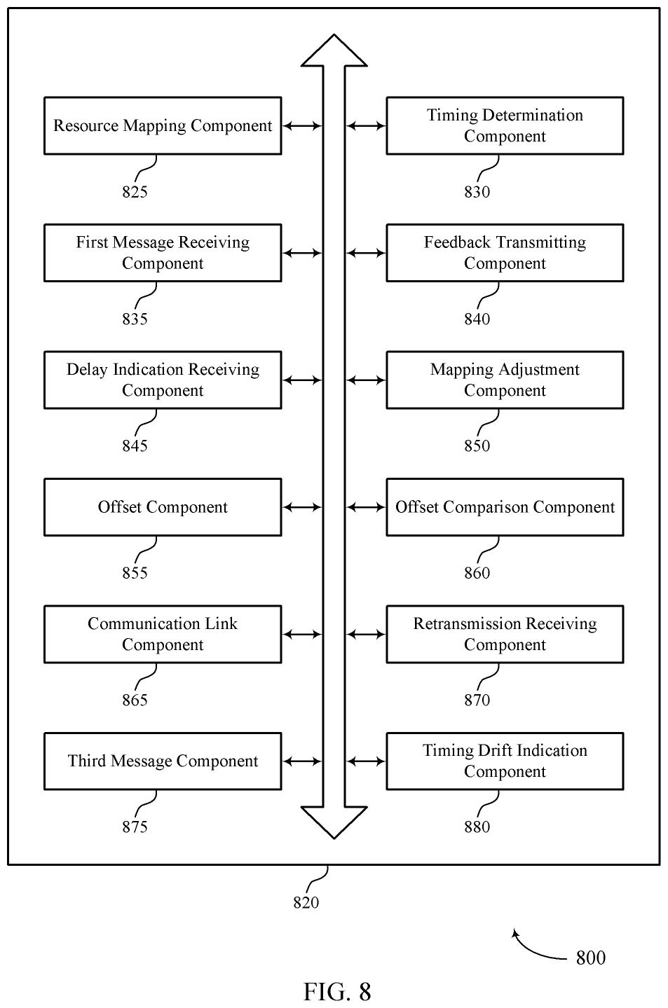

FIG. 8 shows a block diagram 800 of a communications manager 820 that supports inter-communication technology aggregation of asynchronous radio frequency and visible light communication links in accordance with aspects of the present disclosure. The communications manager 820 may be an example of aspects of a communications manager 620, a communications manager 720, or both, as described herein. The communications manager 820, or various components thereof, may be an example of means for performing various aspects of inter-communication technology aggregation of asynchronous radio frequency and visible light communication links as described herein. For example, the communications manager 820 may include a resource mapping component 825, a timing determination component 830, a first message receiving component 835, a feedback transmitting component 840, a delay indication receiving component 845, a mapping adjustment component 850, an offset component 855, an offset comparison component 860, a communication link component 865, a retransmission receiving component 870, a third message component 875, a timing drift indication component 880, or any combination thereof. Each of these components may communicate, directly or indirectly, with one another (e.g., via one or more buses).

The communications manager 820 may support wireless communication at a UE in accordance with examples as disclosed herein. The resource mapping component 825 may be configured as or otherwise support a means for receiving, from a first network device using a first communication technology, an indication of a resource mapping between a first set of time resources for downlink communications using the first communication technology and a second set of time resources for downlink communications using a second communication technology. The timing determination component 830 may be configured as or otherwise support a means for determining a timing for receiving a first message from a second network device using the second communication technology based on receiving the indication of the resource mapping. The first message receiving component 835 may be configured as or otherwise support a means for receiving, from the second network device, the first message using the second communication technology based on determining the timing.

In some examples, the feedback transmitting component 840 may be configured as or otherwise support a means for transmitting, to the first network device, a second message using the first communication technology based on receiving the first message from the second network device using the second communication technology, the second message including feedback information associated with the first message received from the second network device using the second communication technology.

In some examples, the retransmission receiving component 870 may be configured as or otherwise support a means for receiving, from the first network device, one or more retransmissions of the first message using the first communication technology, where the one or more retransmissions are received based on transmitting the second message including feedback information.

In some examples, the third message component 875 may be configured as or otherwise support a means for transmitting, to the first network device using the first communication technology, a third message including feedback information associated with messages received from the first network device using the first communication technology.

In some examples, the third message and the second message are transmitted using a time-division multiplexing pattern based on a single Tx capability of the UE.

In some examples, the third message and the second message are transmitted simultaneously based on a dual-Tx capability of the UE.

In some examples, the delay indication receiving component 845 may be configured as or otherwise support a means for receiving, from the first network device using the first communication technology, control signaling indicating a delay associated with messages communicated using the second communication technology relative to the first communication technology, where receiving the first message using the second communication technology is based on receiving the control signaling.

In some examples, to support receiving the indication of the resource mapping, the resource mapping component 825 may be configured as or otherwise support a means for receiving, an indication that the first set of time resources for downlink communications using the first communication technology is mapped to the second set of time resources for downlink communications using the second communication technology, where receiving, from the second network device, the first message using the second communication technology is based on receiving the indication.

In some examples, to support receiving the indication of the resource mapping, the resource mapping component 825 may be configured as or otherwise support a means for receiving, an indication that the second set of time resources for downlink communications using the second communication technology is mapped to a third set of time resources for uplink communications using the first communication technology. In some examples, to support receiving the indication of the resource mapping, the resource mapping component 825 may be configured as or otherwise support a means for transmitting, to the first network device, a second message using the first communication technology based on receiving the indication, where the second message includes feedback information associated with the first message received from the second network device using the second communication technology.

In some examples, to support receiving the indication of the resource mapping, the resource mapping component 825 may be configured as or otherwise support a means for receiving, as part of the indication, one or more system frame numbers associated with the first communication technology or the second communication technology or both, one or more frame offsets between the first communication technology and the second communication technology, and one or more slot durations or frame lengths associated with the first communication technology or the second communication technology or both, or any combination thereof. In some examples, to support receiving the indication of the resource mapping, the resource mapping component 825 may be configured as or otherwise support a means for determining a timing for receiving the first message using the second communication technology based on any combination of the one or more system frame numbers, the one or more frame offsets, and the one or more slot durations or frame lengths, where receiving the first message is based on determining the timing.

In some examples, the mapping adjustment component 850 may be configured as or otherwise support a means for aligning a timing associated with the first communication technology and a timing associated with the second communication technology, where the resource mapping between the first set of time resources for downlink communications using the first communication technology and the second set of time resources for downlink communications using the second communication technology is based on the aligning.

In some examples, the offset component 855 may be configured as or otherwise support a means for determining a first offset between a time resource associated with the first communication technology and a time resource associated with the second communication technology. In some examples, the offset component 855 may be configured as or otherwise support a means for determining a second offset between the time resource associated with the first communication technology and the time resource associated with the second communication technology. In some examples, the offset comparison component 860 may be configured as or otherwise support a means for determining a difference between the first offset and the second offset corresponding to a timing drift between the first communication technology and the second communication technology.

In some examples, the timing drift indication component 880 may be configured as or otherwise support a means for transmitting an indication of the timing drift to the first network device based on determining the difference associated with the timing drift. In some examples, the mapping adjustment component 850 may be configured as or otherwise support a means for adjusting the resource mapping based on the timing drift satisfying a threshold.

In some examples, the first network device includes a base station and the second network device includes a visible light communications access point.

In some examples, the first communication technology includes a radio access technology and the second communication technology includes visible light communications.

In some examples, the communication link component 865 may be configured as or otherwise support a means for establishing a first communication link with the first network device using the first communication technology. In some examples, the communication link component 865 may be configured as or otherwise support a means for establishing a second communication link with the second network device using the second communication technology, where one or more time resources associated with the first communication link are asynchronous with one or more time resources associated with the second communication link.

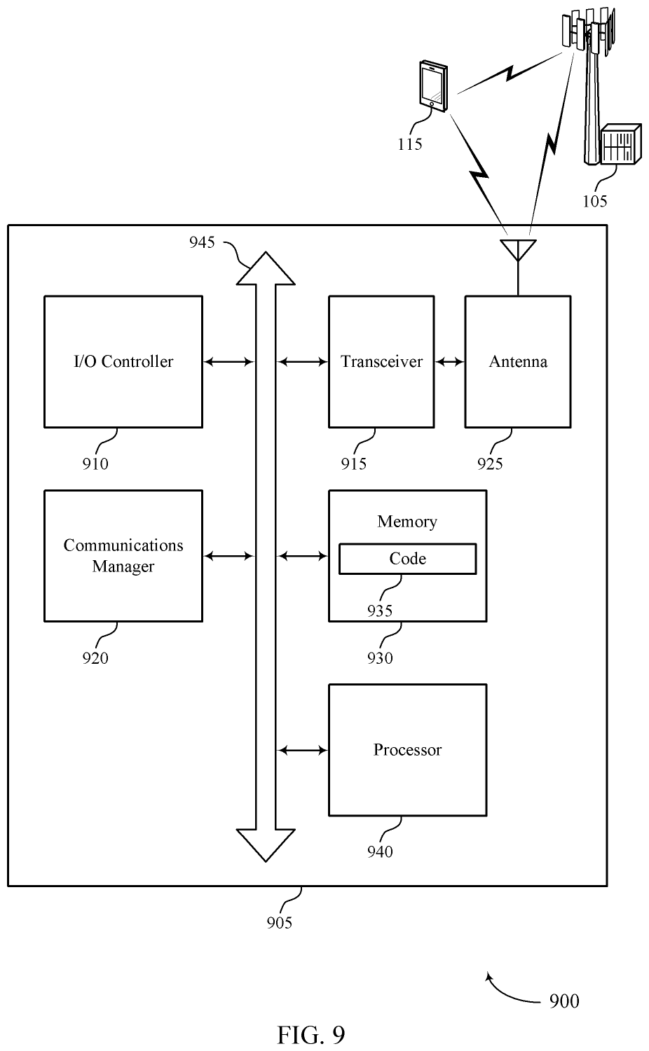

FIG. 9 shows a diagram of a system 900 including a device 905 that supports inter-communication technology aggregation of asynchronous radio frequency and visible light communication links in accordance with aspects of the present disclosure. The device 905 may be an example of or include the components of a device 605, a device 705, or a UE 115 as described herein. The device 905 may communicate wirelessly with one or more base stations 105, UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting inter-communication technology aggregation of asynchronous radio frequency and visible light communication links). For example, the device 905 or a component of the device 905 may include a processor 940 and memory 930 coupled to the processor 940, the processor 940 and memory 930 configured to perform various functions described herein.

The communications manager 920 may support wireless communication at a UE in accordance with examples as disclosed herein. For example, the communications manager 920 may be configured as or otherwise support a means for receiving, from a first network device using a first communication technology, an indication of a resource mapping between a first set of time resources for downlink communications using the first communication technology and a second set of time resources for downlink communications using a second communication technology. The communications manager 920 may be configured as or otherwise support a means for determining a timing for receiving a first message from a second network device using the second communication technology based on receiving the indication of the resource mapping. The communications manager 920 may be configured as or otherwise support a means for receiving, from the second network device, the first message using the second communication technology based on determining the timing.

By including or configuring the communications manager 920 in accordance with examples as described herein, the device 905 may support techniques for synchronized communications between network devices using different communication technologies, which may improve coordination between devices. For example, the device 905 may support communicating with other devices based on one or more resource mappings, which may enable effective and efficient communications. In some cases, the device 905 may support performing one or more retransmissions over an RF link, which may reduce latency associated with backhaul link communications. The techniques for reduced processing may allow the device 905 to reduce the processing overhead at the device 905 and more efficiently perform feedback message signaling or retransmission signaling. Accordingly, more efficiently performing feedback message signaling may reduce power consumption at the device 905.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of inter-communication technology aggregation of asynchronous radio frequency and visible light communication links as described herein, or the processor 940 and the memory 930 may be otherwise configured to perform or support such operations.

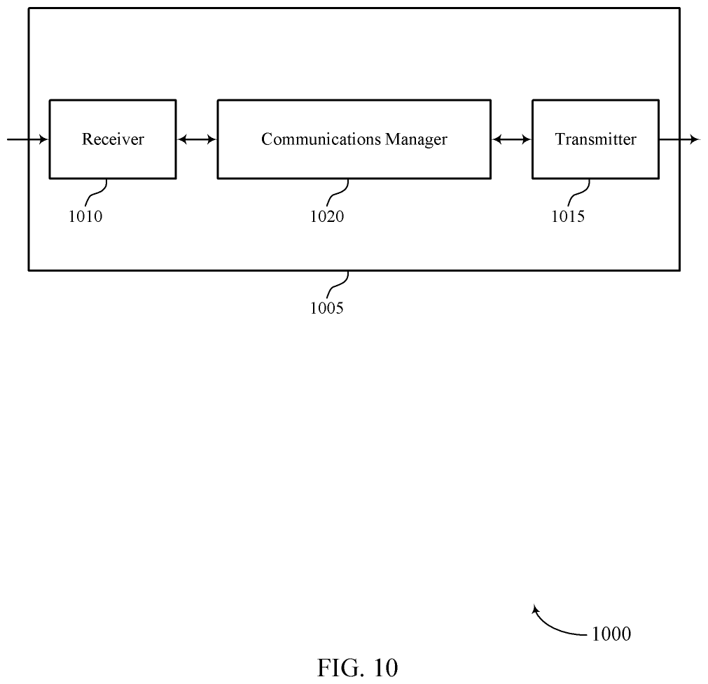

FIG. 10 shows a block diagram 1000 of a device 1005 that supports inter-communication technology aggregation of asynchronous radio frequency and visible light communication links in accordance with aspects of the present disclosure. The device 1005 may be an example of aspects of a base station 105 (e.g., that uses a first communication technology, such as LTE or 5G) as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to inter-communication technology aggregation of asynchronous radio frequency and visible light communication links). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to inter-communication technology aggregation of asynchronous radio frequency and visible light communication links). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of inter-communication technology aggregation of asynchronous radio frequency and visible light communication links as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1020 may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communication at a first network device in accordance with examples as disclosed herein. For example, the communications manager 1020 may be configured as or otherwise support a means for determining a resource mapping between a first set of time resources for downlink communications using a first communication technology and a second set of time resources for downlink communications using a second communication technology. The communications manager 1020 may be configured as or otherwise support a means for transmitting, to a UE using the first communication technology, an indication of the resource mapping. The communications manager 1020 may be configured as or otherwise support a means for monitoring for one or more messages from the UE based on the resource mapping.

By including or configuring the communications manager 1020 in accordance with examples as described herein, the device 1005 (e.g., a processor controlling or otherwise coupled to the receiver 1010, the transmitter 1015, the communications manager 1020, or a combination thereof) may support techniques for synchronized communications between network devices using different communication technologies, which may reduce processing, reduce power consumption, and lead to more efficient utilization of communication resources. For example, the device 1005 may support reduced processing associated with one or more feedback processes. The techniques for reduced processing may allow the device 1005 to reduce the processing overhead at the device 1005 and more efficiently perform feedback message signaling or retransmission signaling. Accordingly, more efficiently performing feedback message signaling may reduce power consumption at the device 1005.

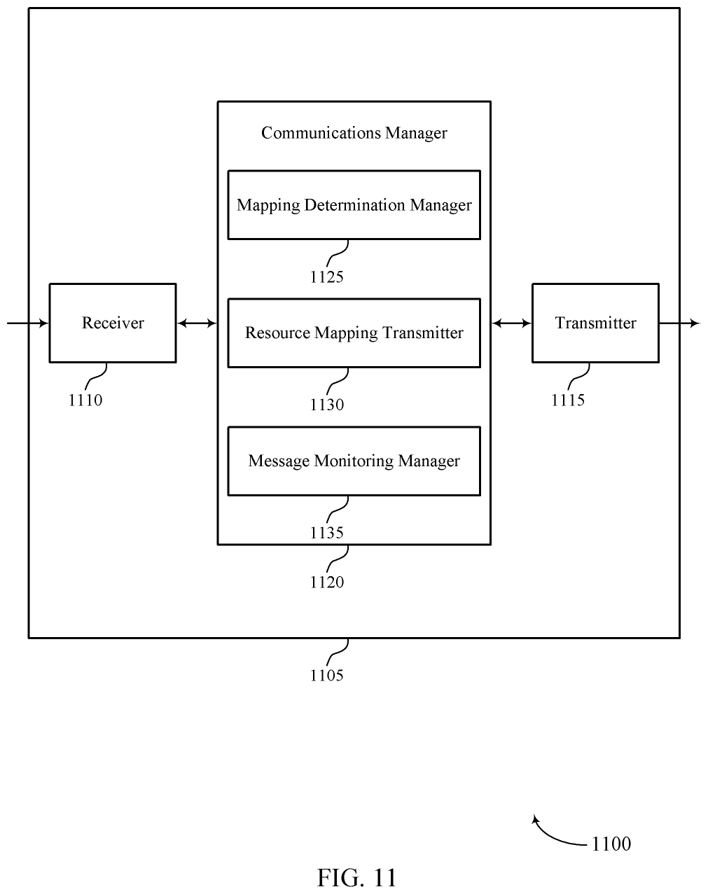

FIG. 11 shows a block diagram 1100 of a device 1105 that supports inter-communication technology aggregation of asynchronous radio frequency and visible light communication links in accordance with aspects of the present disclosure. The device 1105 may be an example of aspects of a device 1005 or a base station 105 (e.g., that uses a first communication technology, such as LTE or 5G) as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to inter-communication technology aggregation of asynchronous radio frequency and visible light communication links). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to inter-communication technology aggregation of asynchronous radio frequency and visible light communication links). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of inter-communication technology aggregation of asynchronous radio frequency and visible light communication links as described herein. For example, the communications manager 1120 may include a mapping determination manager 1125, a resource mapping transmitter 1130, a message monitoring manager 1135, or any combination thereof. The communications manager 1120 may be an example of aspects of a communications manager 1020 as described herein. In some examples, the communications manager 1120, or various components thereof, may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communication at a first network device in accordance with examples as disclosed herein. The mapping determination manager 1125 may be configured as or otherwise support a means for determining a resource mapping between a first set of time resources for downlink communications using a first communication technology and a second set of time resources for downlink communications using a second communication technology. The resource mapping transmitter 1130 may be configured as or otherwise support a means for transmitting, to a UE using the first communication technology, an indication of the resource mapping. The message monitoring manager 1135 may be configured as or otherwise support a means for monitoring for one or more messages from the UE based on the resource mapping.

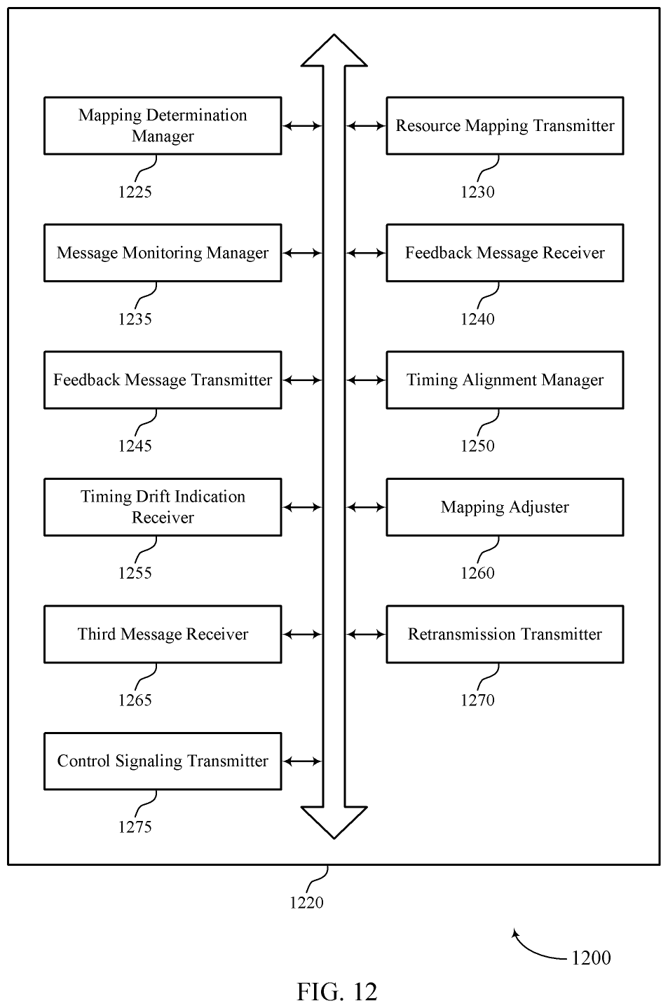

FIG. 12 shows a block diagram 1200 of a communications manager 1220 that supports inter-communication technology aggregation of asynchronous radio frequency and visible light communication links in accordance with aspects of the present disclosure. The communications manager 1220 may be an example of aspects of a communications manager 1020, a communications manager 1120, or both, as described herein. The communications manager 1220, or various components thereof, may be an example of means for performing various aspects of inter-communication technology aggregation of asynchronous radio frequency and visible light communication links as described herein. For example, the communications manager 1220 may include a mapping determination manager 1225, a resource mapping transmitter 1230, a message monitoring manager 1235, a feedback message receiver 1240, a feedback message transmitter 1245, a timing alignment manager 1250, a timing drift indication receiver 1255, a mapping adjuster 1260, a third message receiver 1265, a retransmission transmitter 1270, a control signaling transmitter 1275, or any combination thereof. Each of these components may communicate, directly or indirectly, with one another (e.g., via one or more buses).

The communications manager 1220 may support wireless communication at a first network device in accordance with examples as disclosed herein. The mapping determination manager 1225 may be configured as or otherwise support a means for determining a resource mapping between a first set of time resources for downlink communications using a first communication technology and a second set of time resources for downlink communications using a second communication technology. The resource mapping transmitter 1230 may be configured as or otherwise support a means for transmitting, to a UE using the first communication technology, an indication of the resource mapping. The message monitoring manager 1235 may be configured as or otherwise support a means for monitoring for one or more messages from the UE based on the resource mapping.

In some examples, the feedback message receiver 1240 may be configured as or otherwise support a means for receiving, from the UE, a second message using the first communication technology based on the UE receiving a first message using the second communication technology from a second network device. In some examples, the feedback message transmitter 1245 may be configured as or otherwise support a means for transmitting, via a backhaul connection, to the second network device, feedback information associated with the first message based on receiving the second message from the UE.

In some examples, the retransmission transmitter 1270 may be configured as or otherwise support a means for transmitting, to the UE, one or more retransmissions of the first message using the first communication technology, where the one or more retransmissions of the first message are transmitted based on receiving the second message including feedback information.

In some examples, the control signaling transmitter 1275 may be configured as or otherwise support a means for transmitting, to the UE using the first communication technology, control signaling indicating a delay associated with messages communicated using the second communication technology relative to the first communication technology, where the delay is associated with the UE receiving the first message using the second communication technology.

In some examples, to support transmitting the indication of the resource mapping, the resource mapping transmitter 1230 may be configured as or otherwise support a means for transmitting, an indication that the first set of time resources for downlink communications using the first communication technology is mapped to the second set of time resources for downlink communications using the second communication technology, where monitoring for one or more messages from the UE is based on transmitting the indication.

In some examples, to support transmitting the indication of the resource mapping, the resource mapping transmitter 1230 may be configured as or otherwise support a means for transmitting, an indication that the second set of time resources for downlink communications using the second communication technology is mapped to a third set of time resources for uplink communications using the first communication technology. In some examples, to support transmitting the indication of the resource mapping, the resource mapping transmitter 1230 may be configured as or otherwise support a means for receiving, from the UE, a second message using the first communication technology based on transmitting the indication, where the second message includes feedback information associated with a first message received from a second network device using the second communication technology.

In some examples, to support transmitting the indication of the resource mapping, the resource mapping transmitter 1230 may be configured as or otherwise support a means for transmitting, as part of the indication, one or more system frame numbers associated with the first communication technology or the second communication technology or both, one or more frame offsets between the first communication technology and the second communication technology, and one or more slot durations or frame lengths associated with the first communication technology or the second communication technology or both, or any combination thereof.

In some examples, the timing alignment manager 1250 may be configured as or otherwise support a means for aligning a timing associated with the first communication technology and a timing associated with the second communication technology, where the resource mapping between the first set of time resources for downlink communications using the first communication technology and the second set of time resources for downlink communications using the second communication technology is based on the aligning.

In some examples, the timing drift indication receiver 1255 may be configured as or otherwise support a means for receiving, from the UE, an indication of a timing drift corresponding to a measured difference between a first offset and a second offset. In some examples, the mapping adjuster 1260 may be configured as or otherwise support a means for adjusting the resource mapping based on the timing drift satisfying a threshold.

In some examples, the third message receiver 1265 may be configured as or otherwise support a means for receiving, from the UE, using the first communication technology, a third message including feedback information associated with messages received from the first network device using the first communication technology.

In some examples, the third message and a second message are received using a time-division multiplexing pattern based on a single Tx capability of the UE.

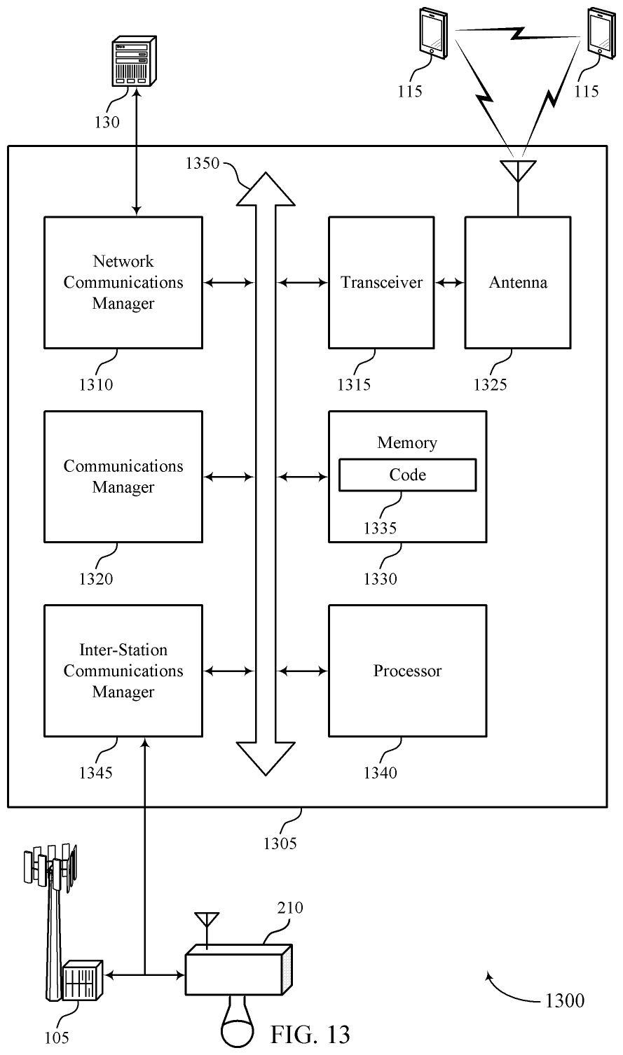

FIG. 13 shows a diagram of a system 1300 including a device 1305 that supports inter-communication technology aggregation of asynchronous radio frequency and visible light communication links in accordance with aspects of the present disclosure. The device 1305 may be an example of or include the components of a device 1005, a device 1105, or a base station 105 (e.g., that uses a first communication technology, such as LTE or 5G) as described herein. The device 1305 may communicate wirelessly with one or more base stations 105 (e.g., that uses a first communication technology, such as LTE or 5G), UEs 115, network device 210 that uses a second communication technology (such as visible light communications), or any combination thereof. The device 1305 may include components for bi-directional voice and data communications including components for transmitting and receiving communications, such as a communications manager 1320, a network communications manager 1310, a transceiver 1315, an antenna 1325, a memory 1330, code 1335, a processor 1340, and an inter-station communications manager 1345. These components may be in electronic communication or otherwise coupled (e.g., operatively, communicatively, functionally, electronically, electrically) via one or more buses (e.g., a bus 1350).

The network communications manager 1310 may manage communications with a core network 130 (e.g., via one or more wired backhaul links). For example, the network communications manager 1310 may manage the transfer of data communications for client devices, such as one or more UEs 115.

In some cases, the device 1305 may include a single antenna 1325. However, in some other cases the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include RAM and ROM. The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a BIOS which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting inter-communication technology aggregation of asynchronous radio frequency and visible light communication links). For example, the device 1305 or a component of the device 1305 may include a processor 1340 and memory 1330 coupled to the processor 1340, the processor 1340 and memory 1330 configured to perform various functions described herein.

The inter-station communications manager 1345 may manage communications with other base stations 105 or network devices 210, and may include a controller or scheduler for controlling communications with UEs 115 in cooperation with other base stations 105 or network devices 210. For example, the inter-station communications manager 1345 may coordinate scheduling for transmissions to UEs 115 for various interference mitigation techniques such as beamforming or joint transmission. In some examples, the inter-station communications manager 1345 may provide an X2 interface within an LTE/LTE-A wireless communications network technology to provide communication between base stations 105 or network devices 210. In some examples, the inter-station communications manager 1345 may provide an interface between base stations 105 using a first communication technology (e.g., such as LTE or 5G) and network devices 210 using a second communication technology (e.g., such as visible light communications).

The communications manager 1320 may support wireless communication at a first network device in accordance with examples as disclosed herein. For example, the communications manager 1320 may be configured as or otherwise support a means for determining a resource mapping between a first set of time resources for downlink communications using a first communication technology and a second set of time resources for downlink communications using a second communication technology. The communications manager 1320 may be configured as or otherwise support a means for transmitting, to a UE using the first communication technology, an indication of the resource mapping. The communications manager 1320 may be configured as or otherwise support a means for monitoring for one or more messages from the UE based on the resource mapping.

By including or configuring the communications manager 1320 in accordance with examples as described herein, the device 1305 may support techniques for synchronized communications between network devices using different communication technologies, which may improve coordination between devices. For example, the device 1305 may support communicating with other devices based on one or more resource mappings, which may enable effective and efficient communications. In some cases, the device 1305 may support performing one or more retransmissions over an RF link, which may reduce latency associated with backhaul link communications. The techniques for reduced processing may allow the device 1305 to reduce the processing overhead at the device 1305 and more efficiently perform feedback message signaling or retransmission signaling. Accordingly, more efficiently performing feedback message signaling may reduce power consumption at the device 1305.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of inter-communication technology aggregation of asynchronous radio frequency and visible light communication links as described herein, or the processor 1340 and the memory 1330 may be otherwise configured to perform or support such operations.

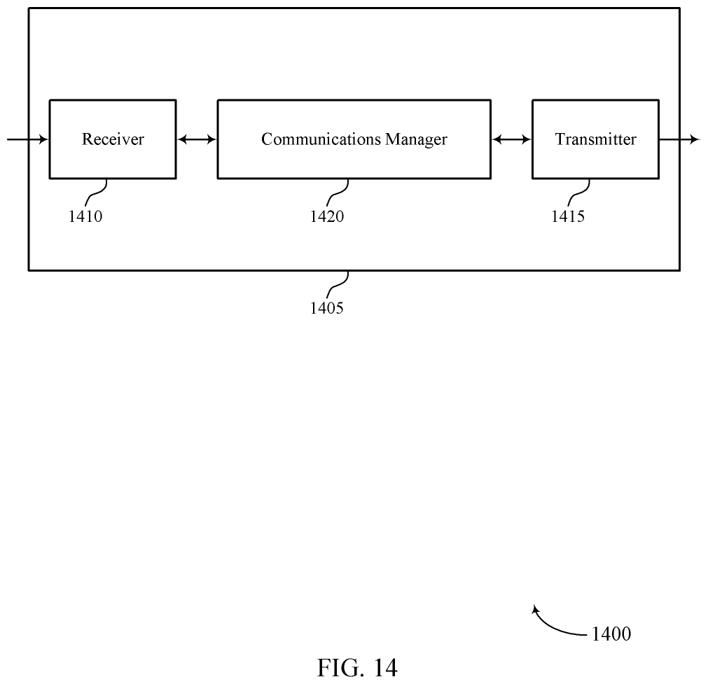

FIG. 14 shows a block diagram 1400 of a device 1405 that supports inter-communication technology aggregation of asynchronous radio frequency and visible light communication links in accordance with aspects of the present disclosure. The device 1405 may be an example of aspects of a-network device 210 that uses a second communication technology (e.g., visible light communication) as described herein. The device 1405 may include a receiver 1410, a transmitter 1415, and a communications manager 1420. The device 1405 may also include a processor. Each of these components may be in communication with one another (e.g., via one or more buses).

The receiver 1410 may provide a means for receiving information such as packets, user data, control information, or any combination thereof associated with various information channels (e.g., control channels, data channels, information channels related to inter-communication technology aggregation of asynchronous radio frequency and visible light communication links). Information may be passed on to other components of the device 1405. The receiver 1410 may utilize a single antenna or a set of multiple antennas.

The transmitter 1415 may provide a means for transmitting signals generated by other components of the device 1405. For example, the transmitter 1415 may transmit information such as packets, user data, control information, or any combination thereof associated with various information channels (e.g., control channels, data channels, information channels related to inter-communication technology aggregation of asynchronous radio frequency and visible light communication links). In some examples, the transmitter 1415 may be co-located with a receiver 1410 in a transceiver module. The transmitter 1415 may utilize a single antenna or a set of multiple antennas.

The communications manager 1420, the receiver 1410, the transmitter 1415, or various combinations thereof or various components thereof may be examples of means for performing various aspects of inter-communication technology aggregation of asynchronous radio frequency and visible light communication links as described herein. For example, the communications manager 1420, the receiver 1410, the transmitter 1415, or various combinations or components thereof may support a method for performing one or more of the functions described herein.

In some examples, the communications manager 1420, the receiver 1410, the transmitter 1415, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1420, the receiver 1410, the transmitter 1415, or various combinations or components thereof may be implemented in code (e.g., as communications management software or firmware) executed by a processor. If implemented in code executed by a processor, the functions of the communications manager 1420, the receiver 1410, the transmitter 1415, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1420 may be configured to perform various operations (e.g., receiving, monitoring, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to receive information, transmit information, or perform various other operations as described herein.

The communications manager 1420 may support wireless communication at a second network device in accordance with examples as disclosed herein. For example, the communications manager 1420 may be configured as or otherwise support a means for receiving, from a first network device using a first communication technology, an indication of a resource mapping between a first set of time resources for downlink communications using the first communication technology and a second set of time resources for downlink communications using a second communication technology. The communications manager 1420 may be configured as or otherwise support a means for determining a timing for transmitting a first message to a UE using the second communication technology based on receiving the indication of the resource mapping. The communications manager 1420 may be configured as or otherwise support a means for transmitting, to the UE, the first message using the second communication technology.

By including or configuring the communications manager 1420 in accordance with examples as described herein, the device 1405 (e.g., a processor controlling or otherwise coupled to the receiver 1410, the transmitter 1415, the communications manager 1420, or a combination thereof) may support techniques for synchronized communications between network devices using different communication technologies, which may reduce processing, reduce power consumption, and lead to more efficient utilization of communication resources. For example, the device 1405 may support reduced processing associated with one or more feedback processes. The techniques for reduced processing may allow the device 1405 to reduce the processing overhead at the device 1405 and more efficiently perform feedback message signaling or retransmission signaling. Accordingly, more efficiently performing feedback message signaling may reduce power consumption at the device 1405.

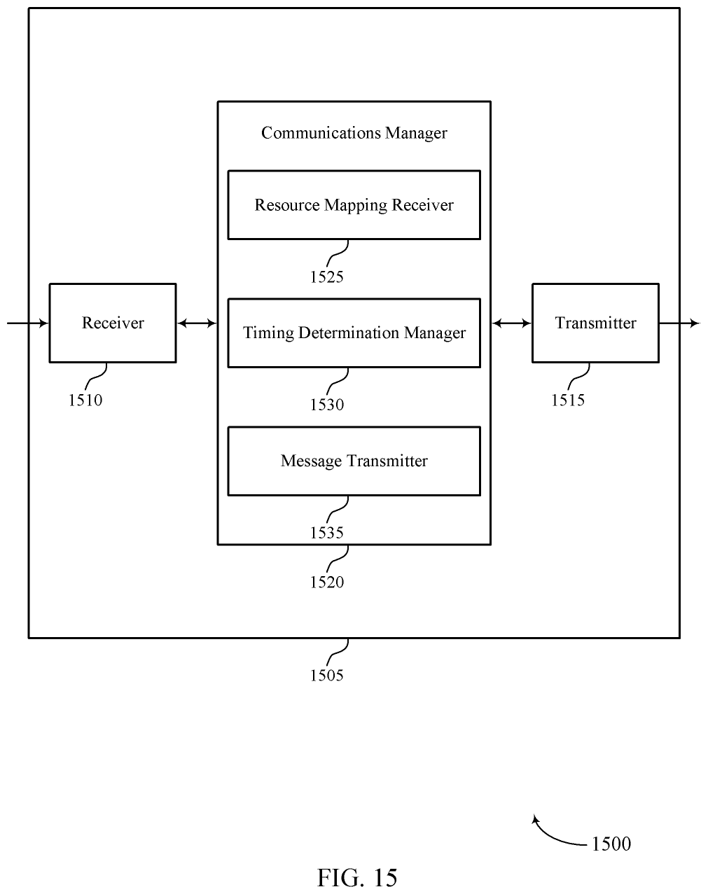

FIG. 15 shows a block diagram 1500 of a device 1505 that supports inter-communication technology aggregation of asynchronous radio frequency and visible light communication links in accordance with aspects of the present disclosure. The device 1505 may be an example of aspects of a device 1405 or a network device 210 that uses a second communication technology (e.g., visible light communication) as described herein. The device 1505 may include a receiver 1510, a transmitter 1515, and a communications manager 1520. The device 1505 may also include a processor. Each of these components may be in communication with one another (e.g., via one or more buses).

The receiver 1510 may provide a means for receiving information such as packets, user data, control information, or any combination thereof associated with various information channels (e.g., control channels, data channels, information channels related to inter-communication technology aggregation of asynchronous radio frequency and visible light communication links). Information may be passed on to other components of the device 1505. The receiver 1510 may utilize a single antenna or a set of multiple antennas.

The transmitter 1515 may provide a means for transmitting signals generated by other components of the device 1505. For example, the transmitter 1515 may transmit information such as packets, user data, control information, or any combination thereof associated with various information channels (e.g., control channels, data channels, information channels related to inter-communication technology aggregation of asynchronous radio frequency and visible light communication links). In some examples, the transmitter 1515 may be co-located with a receiver 1510 in a transceiver module. The transmitter 1515 may utilize a single antenna or a set of multiple antennas.

The device 1505, or various components thereof, may be an example of means for performing various aspects of inter-communication technology aggregation of asynchronous radio frequency and visible light communication links as described herein. For example, the communications manager 1520 may include a resource mapping receiver 1525, a timing determination manager 1530, a message transmitter 1535, or any combination thereof. The communications manager 1520 may be an example of aspects of a communications manager 1420 as described herein. In some examples, the communications manager 1520, or various components thereof, may be configured to perform various operations (e.g., receiving, monitoring, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to receive information, transmit information, or perform various other operations as described herein.

The communications manager 1520 may support wireless communication at a second network device in accordance with examples as disclosed herein. The resource mapping receiver 1525 may be configured as or otherwise support a means for receiving, from a first network device using a first communication technology, an indication of a resource mapping between a first set of time resources for downlink communications using the first communication technology and a second set of time resources for downlink communications using a second communication technology. The timing determination manager 1530 may be configured as or otherwise support a means for determining a timing for transmitting a first message to a UE using the second communication technology based on receiving the indication of the resource mapping. The message transmitter 1535 may be configured as or otherwise support a means for transmitting, to the UE, the first message using the second communication technology.

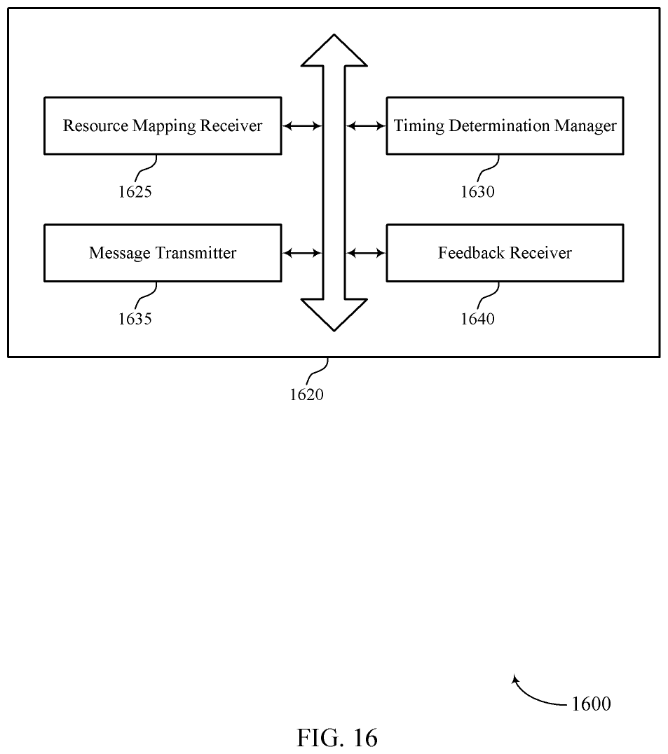

FIG. 16 shows a block diagram 1600 of a communications manager 1620 that supports inter-communication technology aggregation of asynchronous radio frequency and visible light communication links in accordance with aspects of the present disclosure. The communications manager 1620 may be an example of aspects of a communications manager 1420, a communications manager 1520, or both, as described herein. The communications manager 1620, or various components thereof, may be an example of means for performing various aspects of inter-communication technology aggregation of asynchronous radio frequency and visible light communication links as described herein. For example, the communications manager 1620 may include a resource mapping receiver 1625, a timing determination manager 1630, a message transmitter 1635, a feedback receiver 1640, or any combination thereof. Each of these components may communicate, directly or indirectly, with one another (e.g., via one or more buses).

The communications manager 1620 may support wireless communication at a second network device in accordance with examples as disclosed herein. The resource mapping receiver 1625 may be configured as or otherwise support a means for receiving, from a first network device using a first communication technology, an indication of a resource mapping between a first set of time resources for downlink communications using the first communication technology and a second set of time resources for downlink communications using a second communication technology. The timing determination manager 1630 may be configured as or otherwise support a means for determining a timing for transmitting a first message to a UE using the second communication technology based on receiving the indication of the resource mapping. The message transmitter 1635 may be configured as or otherwise support a means for transmitting, to the UE, the first message using the second communication technology.

In some examples, the feedback receiver 1640 may be configured as or otherwise support a means for receiving, from the first network device, via a backhaul connection, feedback information associated with the first message.

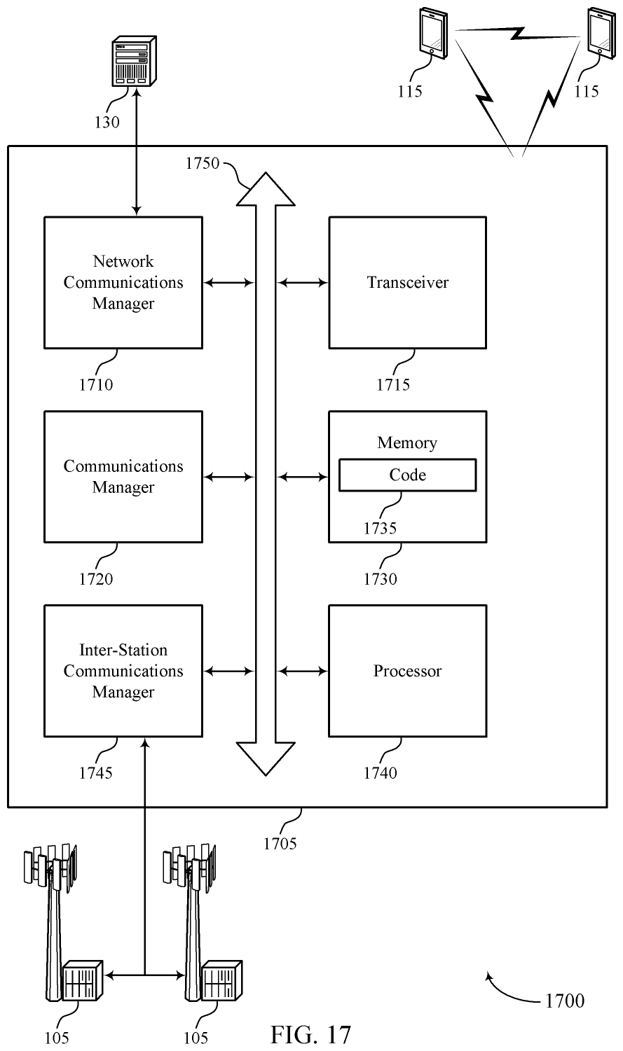

FIG. 17 shows a diagram of a system 1700 including a device 1705 that supports inter-communication technology aggregation of asynchronous radio frequency and visible light communication links in accordance with aspects of the present disclosure. The device 1705 may be an example of or include the components of a device 1405, a device 1505, or a network device 210 that uses a second communication technology (e.g., visible light communication) as described herein. The device 1705 may include components for bi-directional voice and data communications including components for transmitting and receiving communications, such as a communications manager 1720, a network communications manager 1710, a transceiver 1715, an antenna 1725, a memory 1730, code 1735, a processor 1740, and an inter-station communications manager 1745. These components may be in electronic communication or otherwise coupled (e.g., operatively, communicatively, functionally, electronically, electrically) via one or more buses (e.g., a bus 1750).

The network communications manager 1710 may manage communications with a core network 130 (e.g., via one or more wired backhaul links). For example, the network communications manager 1710 may manage the transfer of data communications for client devices, such as one or more UEs 115.

In some cases, the device 1705 may include a transceiver 1715, which may communicate bi-directionally, via one or more transmitters and/or one or more receivers, wired, or wireless links as described herein. For example, the transceiver 1715 may represent a wireless transceiver and may communicate bi-directionally with another wireless transceiver. The transceiver 1715 may also include a modem to modulate the packets, to provide the modulated packets to one or more antennas 1725 for transmission, and to demodulate packets received from the one or more antennas 1725. The transceiver 1715 may be an example of a transmitter 1415, a transmitter 1515, a receiver 1410, a receiver 1510, or any combination thereof or component thereof, as described herein. In some examples, the transceiver may be configured to communicate using visible light. In such examples, the device 1705 may include one or more emitters (e.g., such as a light emitting diode) for transmitting light (at particular frequencies) modulated to include information and the device 1705 may include one or more receivers (such as a photo-detector, camera, or other device for detecting light modulated to include information).

The memory 1730 may include RAM and ROM. The memory 1730 may store computer-readable, computer-executable code 1735 including instructions that, when executed by the processor 1740, cause the device 1705 to perform various functions described herein. The code 1735 may be stored in a non-transitory computer-readable medium such as system memory or another type of memory. In some cases, the code 1735 may not be directly executable by the processor 1740 but may cause a computer (e.g., when compiled and executed) to perform functions described herein. In some cases, the memory 1730 may contain, among other things, a BIOS which may control basic hardware or software operation such as the interaction with peripheral components or devices.

The processor 1740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1740 may be configured to operate a memory array using a memory controller. In some other cases, a memory controller may be integrated into the processor 1740. The processor 1740 may be configured to execute computer-readable instructions stored in a memory (e.g., the memory 1730) to cause the device 1705 to perform various functions (e.g., functions or tasks supporting inter-communication technology aggregation of asynchronous radio frequency and visible light communication links). For example, the device 1705 or a component of the device 1705 may include a processor 1740 and memory 1730 coupled to the processor 1740, the processor 1740 and memory 1730 configured to perform various functions described herein.

The inter-station communications manager 1745 may manage communications with other network devices 210 (that use the second communication technology) or other base stations 105 (that use the first communication technology), and may include a controller or scheduler for controlling communications with UEs 115 in cooperation with other network devices 210 or other base stations 105 or both. For example, the inter-station communications manager 1745 may coordinate scheduling for transmissions to UEs 115 for various interference mitigation techniques such as joint transmission. In some examples, the inter-station communications manager 1745 may provide an X2 interface within an LTE/LTE-A wireless communications network technology to provide communication between network devices 210, base stations 105, or both. In some examples, the inter-station communications manager 1745 may provide an interface between base stations 105 using a first communication technology (e.g., such as LTE or 5G) and network devices 210 using a second communication technology (e.g., such as visible light communications).

The communications manager 1720 may support wireless communication at a second network device in accordance with examples as disclosed herein. For example, the communications manager 1720 may be configured as or otherwise support a means for receiving, from a first network device using a first communication technology, an indication of a resource mapping between a first set of time resources for downlink communications using the first communication technology and a second set of time resources for downlink communications using a second communication technology. The communications manager 1720 may be configured as or otherwise support a means for determining a timing for transmitting a first message to a UE using the second communication technology based on receiving the indication of the resource mapping. The communications manager 1720 may be configured as or otherwise support a means for transmitting, to the UE, the first message using the second communication technology.

By including or configuring the communications manager 1720 in accordance with examples as described herein, the device 1705 may support techniques for synchronized communications between network devices using different communication technologies, which may improve coordination between devices. For example, the device 1705 may support communicating with other devices based on one or more resource mappings, which may enable effective and efficient communications. In some cases, the device 1705 may support performing one or more retransmissions over an RF link, which may reduce latency associated with backhaul link communications. The techniques for reduced processing may allow the device 1705 to reduce the processing overhead at the device 1705 and more efficiently perform feedback message signaling or retransmission signaling. Accordingly, more efficiently performing feedback message signaling may reduce power consumption at the device 1705.

In some examples, the communications manager 1720 may be configured to perform various operations (e.g., receiving, monitoring, transmitting) using or otherwise in cooperation with the transceiver 1715, the one or more antennas 1725, or any combination thereof. Although the communications manager 1720 is illustrated as a separate component, in some examples, one or more functions described with reference to the communications manager 1720 may be supported by or performed by the processor 1740, the memory 1730, the code 1735, or any combination thereof. For example, the code 1735 may include instructions executable by the processor 1740 to cause the device 1705 to perform various aspects of inter-communication technology aggregation of asynchronous radio frequency and visible light communication links as described herein, or the processor 1740 and the memory 1730 may be otherwise configured to perform or support such operations.

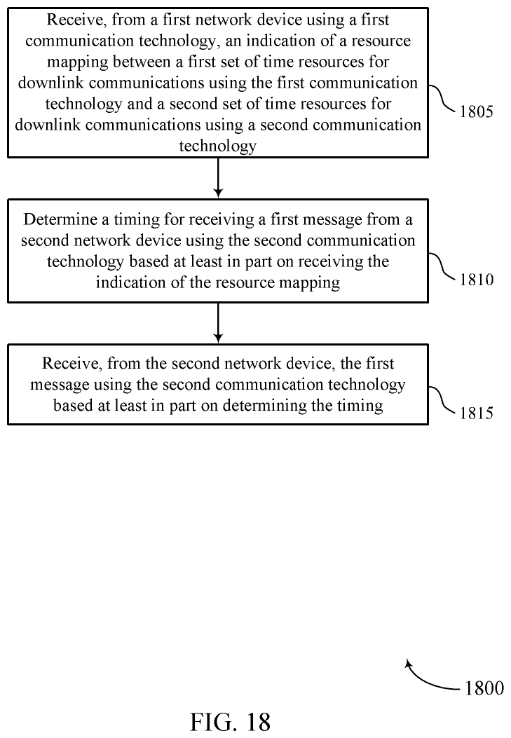

FIG. 18 shows a flowchart illustrating a method 1800 that supports inter-communication technology aggregation of asynchronous radio frequency and visible light communication links in accordance with aspects of the present disclosure. The operations of the method 1800 may be implemented by a UE or its components as described herein. For example, the operations of the method 1800 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1805, the method may include receiving, from a first network device using a first communication technology, an indication of a resource mapping between a first set of time resources for downlink communications using the first communication technology and a second set of time resources for downlink communications using a second communication technology. The operations of 1805 may be performed in accordance with examples as disclosed herein. In some examples, aspects of the operations of 1805 may be performed by a resource mapping component 825 as described with reference to FIG. 8.

At 1810, the method may include determining a timing for receiving a first message from a second network device using the second communication technology based on receiving the indication of the resource mapping. The operations of 1810 may be performed in accordance with examples as disclosed herein. In some examples, aspects of the operations of 1810 may be performed by a timing determination component 830 as described with reference to FIG. 8.

At 1815, the method may include receiving, from the second network device, the first message using the second communication technology based on determining the timing. The operations of 1815 may be performed in accordance with examples as disclosed herein. In some examples, aspects of the operations of 1815 may be performed by a first message receiving component 835 as described with reference to FIG. 8.

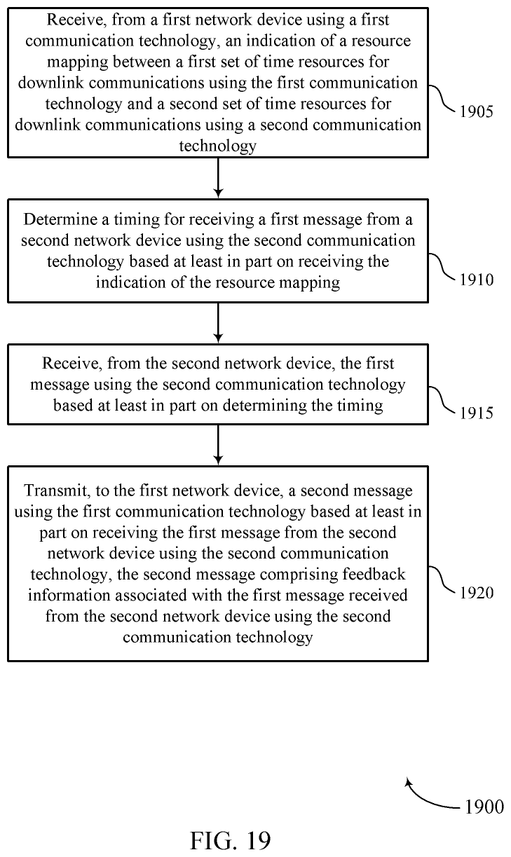

FIG. 19 shows a flowchart illustrating a method 1900 that supports inter-communication technology aggregation of asynchronous radio frequency and visible light communication links in accordance with aspects of the present disclosure. The operations of the method 1900 may be implemented by a UE or its components as described herein. For example, the operations of the method 1900 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1905, the method may include receiving, from a first network device using a first communication technology, an indication of a resource mapping between a first set of time resources for downlink communications using the first communication technology and a second set of time resources for downlink communications using a second communication technology. The operations of 1905 may be performed in accordance with examples as disclosed herein. In some examples, aspects of the operations of 1905 may be performed by a resource mapping component 825 as described with reference to FIG. 8.

At 1910, the method may include determining a timing for receiving a first message from a second network device using the second communication technology based on receiving the indication of the resource mapping. The operations of 1910 may be performed in accordance with examples as disclosed herein. In some examples, aspects of the operations of 1910 may be performed by a timing determination component 830 as described with reference to FIG. 8.

At 1915, the method may include receiving, from the second network device, the first message using the second communication technology based on determining the timing. The operations of 1915 may be performed in accordance with examples as disclosed herein. In some examples, aspects of the operations of 1915 may be performed by a first message receiving component 835 as described with reference to FIG. 8.

At 1920, the method may include transmitting, to the first network device, a second message using the first communication technology based on receiving the first message from the second network device using the second communication technology, the second message including feedback information associated with the first message received from the second network device using the second communication technology. The operations of 1920 may be performed in accordance with examples as disclosed herein. In some examples, aspects of the operations of 1920 may be performed by a feedback transmitting component 840 as described with reference to FIG. 8.

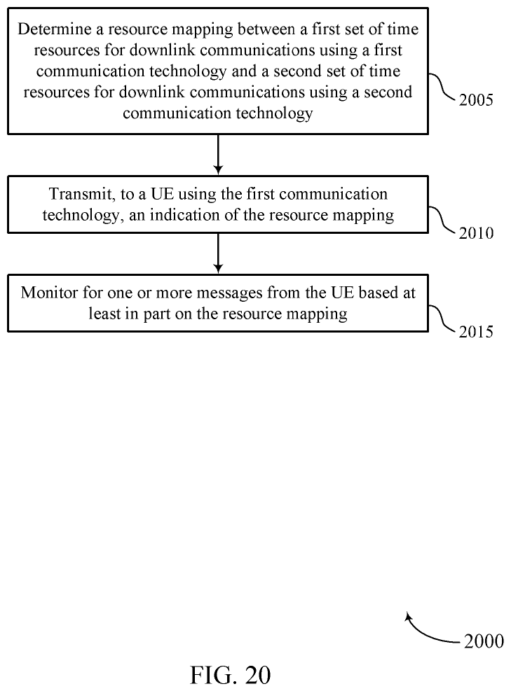

FIG. 20 shows a flowchart illustrating a method 2000 that supports inter-communication technology aggregation of asynchronous radio frequency and visible light communication links in accordance with aspects of the present disclosure. The operations of the method 2000 may be implemented by a base station or its components as described herein. For example, the operations of the method 2000 may be performed by a base station 105 as described with reference to FIGS. 1 through 5 and 10 through 13. In some examples, a base station may execute a set of instructions to control the functional elements of the base station to perform the described functions. Additionally or alternatively, the base station may perform aspects of the described functions using special-purpose hardware.

At 2005, the method may include determining a resource mapping between a first set of time resources for downlink communications using a first communication technology and a second set of time resources for downlink communications using a second communication technology. The operations of 2005 may be performed in accordance with examples as disclosed herein. In some examples, aspects of the operations of 2005 may be performed by a mapping determination manager 1225 as described with reference to FIG. 12.

At 2010, the method may include transmitting, to a UE using the first communication technology, an indication of the resource mapping. The operations of 2010 may be performed in accordance with examples as disclosed herein. In some examples, aspects of the operations of 2010 may be performed by a resource mapping transmitter 1230 as described with reference to FIG. 12.

At 2015, the method may include monitoring for one or more messages from the UE based on the resource mapping. The operations of 2015 may be performed in accordance with examples as disclosed herein. In some examples, aspects of the operations of 2015 may be performed by a message monitoring manager 1235 as described with reference to FIG. 12.

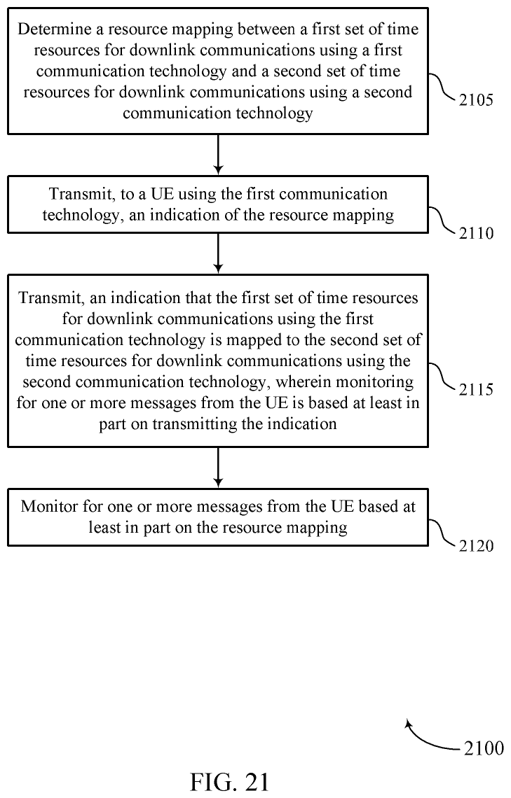

FIG. 21 shows a flowchart illustrating a method 2100 that supports inter-communication technology aggregation of asynchronous radio frequency and visible light communication links in accordance with aspects of the present disclosure. The operations of the method 2100 may be implemented by a base station or its components as described herein. For example, the operations of the method 2100 may be performed by a base station 105 as described with reference to FIGS. 1 through 5 and 10 through 13. In some examples, a base station may execute a set of instructions to control the functional elements of the base station to perform the described functions. Additionally or alternatively, the base station may perform aspects of the described functions using special-purpose hardware.

At 2105, the method may include determining a resource mapping between a first set of time resources for downlink communications using a first communication technology and a second set of time resources for downlink communications using a second communication technology. The operations of 2105 may be performed in accordance with examples as disclosed herein. In some examples, aspects of the operations of 2105 may be performed by a mapping determination manager 1225 as described with reference to FIG. 12.

At 2110, the method may include transmitting, to a UE using the first communication technology, an indication of the resource mapping. The operations of 2110 may be performed in accordance with examples as disclosed herein. In some examples, aspects of the operations of 2110 may be performed by a resource mapping transmitter 1230 as described with reference to FIG. 12.

At 2115, the method may include transmitting, an indication that the first set of time resources for downlink communications using the first communication technology is mapped to the second set of time resources for downlink communications using the second communication technology, where monitoring for one or more messages from the UE is based on transmitting the indication. The operations of 2115 may be performed in accordance with examples as disclosed herein. In some examples, aspects of the operations of 2115 may be performed by a resource mapping transmitter 1230 as described with reference to FIG. 12.

At 2120, the method may include monitoring for one or more messages from the UE based on the resource mapping. The operations of 2120 may be performed in accordance with examples as disclosed herein. In some examples, aspects of the operations of 2120 may be performed by a message monitoring manager 1235 as described with reference to FIG. 12.

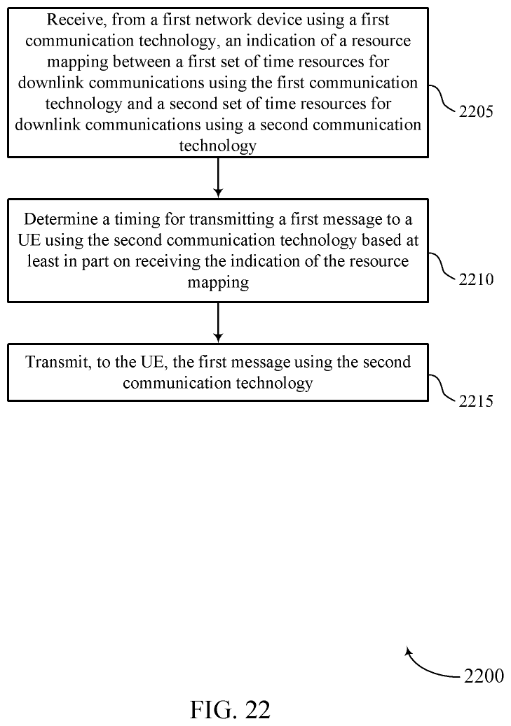

FIG. 22 shows a flowchart illustrating a method 2200 that supports inter-communication technology aggregation of asynchronous radio frequency and visible light communication links in accordance with aspects of the present disclosure. The operations of the method 2200 may be implemented by a network device that uses a second communication technology (e.g., visible light communication) or its components as described herein. For example, the operations of the method 2200 may be performed by a network device as described with reference to FIGS. 1 through 5 and 14 through 17. In some examples, a network device may execute a set of instructions to control the functional elements of the network device to perform the described functions. Additionally or alternatively, the network device may perform aspects of the described functions using special-purpose hardware.

At 2205, the method may include receiving, from a first network device using a first communication technology, an indication of a resource mapping between a first set of time resources for downlink communications using the first communication technology and a second set of time resources for downlink communications using a second communication technology. The operations of 2205 may be performed in accordance with examples as disclosed herein. In some examples, aspects of the operations of 2205 may be performed by a resource mapping receiver 1625 as described with reference to FIG. 16.

At 2210, the method may include determining a timing for transmitting a first message to a UE using the second communication technology based on receiving the indication of the resource mapping. The operations of 2210 may be performed in accordance with examples as disclosed herein. In some examples, aspects of the operations of 2210 may be performed by a timing determination manager 1630 as described with reference to FIG. 16.

At 2215, the method may include transmitting, to the UE, the first message using the second communication technology. The operations of 2215 may be performed in accordance with examples as disclosed herein. In some examples, aspects of the operations of 2215 may be performed by a message transmitter 1635 as described with reference to FIG. 16.

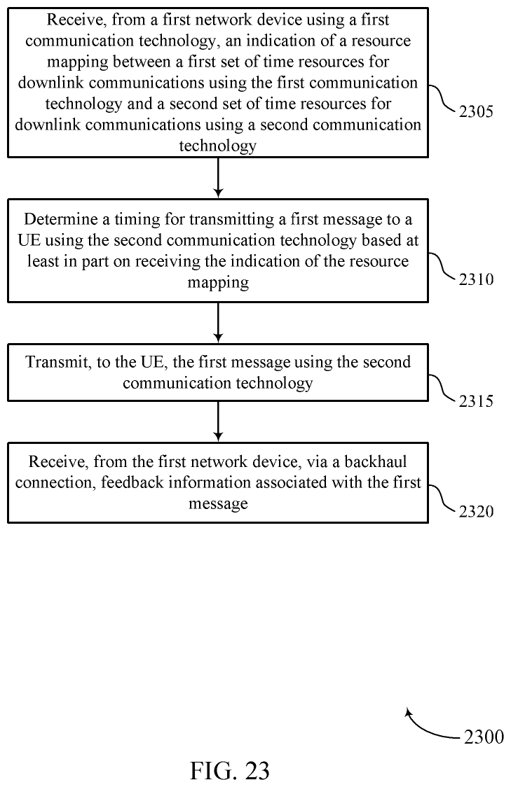

FIG. 23 shows a flowchart illustrating a method 2300 that supports inter-communication technology aggregation of asynchronous radio frequency and visible light communication links in accordance with aspects of the present disclosure. The operations of the method 2300 may be implemented by a network device that uses a second communication technology (e.g., visible light communication) or its components as described herein. For example, the operations of the method 2300 may be performed by a network device as described with reference to FIGS. 1 through 5 and 14 through 17. In some examples, a network device may execute a set of instructions to control the functional elements of the network device to perform the described functions. Additionally or alternatively, the network device may perform aspects of the described functions using special-purpose hardware.

At 2305, the method may include receiving, from a first network device using a first communication technology, an indication of a resource mapping between a first set of time resources for downlink communications using the first communication technology and a second set of time resources for downlink communications using a second communication technology. The operations of 2305 may be performed in accordance with examples as disclosed herein. In some examples, aspects of the operations of 2305 may be performed by a resource mapping receiver 1625 as described with reference to FIG. 16.

At 2310, the method may include determining a timing for transmitting a first message to a UE using the second communication technology based on receiving the indication of the resource mapping. The operations of 2310 may be performed in accordance with examples as disclosed herein. In some examples, aspects of the operations of 2310 may be performed by a timing determination manager 1630 as described with reference to FIG. 16.

At 2315, the method may include transmitting, to the UE, the first message using the second communication technology. The operations of 2315 may be performed in accordance with examples as disclosed herein. In some examples, aspects of the operations of 2315 may be performed by a message transmitter 1635 as described with reference to FIG. 16.

At 2320, the method may include receiving, from the first network device, via a backhaul connection, feedback information associated with the first message. The operations of 2320 may be performed in accordance with examples as disclosed herein. In some examples, aspects of the operations of 2320 may be performed by a feedback receiver 1640 as described with reference to FIG. 16.

The following provides an overview of aspects of the present disclosure:
Aspect 1: A method for wireless communication at a UE, comprising: receiving, from a first network device using a first communication technology, an indication of a resource mapping between a first set of time resources for downlink communications using the first communication technology and a second set of time resources for downlink communications using a second communication technology; determining a timing for receiving a first message from a second network device using the second communication technology based at least in part on receiving the indication of the resource mapping; and receiving, from the second network device, the first message using the second communication technology based at least in part on determining the timing.
Aspect 2: The method of aspect 1, further comprising: transmitting, to the first network device, a second message using the first communication technology based at least in part on receiving the first message from the second network device using the second communication technology, the second message comprising feedback information associated with the first message received from the second network device using the second communication technology.
Aspect 3: The method of aspect 2, further comprising: receiving, from the first network device, one or more retransmissions of the first message using the first communication technology, wherein the one or more retransmissions are received based at least in part on transmitting the second message comprising feedback information.
Aspect 4: The method of any of aspects 2 through 3, further comprising: transmitting, to the first network device using the first communication technology, a third message comprising feedback information associated with messages received from the first network device using the first communication technology.
Aspect 5: The method of aspect 4, wherein the third message and the second message are transmitted using a time-division multiplexing pattern based at least in part on a single Tx capability of the UE.
Aspect 6: The method of aspect 4, wherein the third message and the second message are transmitted simultaneously based at least in part on a dual-Tx capability of the UE.
Aspect 7: The method of any of aspects 1 through 6, further comprising: receiving, from the first network device using the first communication technology, control signaling indicating a delay associated with messages communicated using the second communication technology relative to the first communication technology, wherein receiving the first message using the second communication technology is based at least in part on receiving the control signaling.
Aspect 8: The method of any of aspects 1 through 7, wherein receiving the indication of the resource mapping further comprises: receiving, an indication that the first set of time resources for downlink communications using the first communication technology is mapped to the second set of time resources for downlink communications using the second communication technology, wherein receiving, from the second network device, the first message using the second communication technology is based at least in part on receiving the indication.
Aspect 9: The method of any of aspects 1 through 7, wherein receiving the indication of the resource mapping further comprises: receiving, an indication that the second set of time resources for downlink communications using the second communication technology is mapped to a third set of time resources for uplink communications using the first communication technology; and transmitting, to the first network device, a second message using the first communication technology based at least in part on receiving the indication, wherein the second message comprises feedback information associated with the first message received from the second network device using the second communication technology.
Aspect 10: The method of any of aspects 1 through 7, wherein receiving the indication of the resource mapping further comprises: receiving, as part of the indication, one or more system frame numbers associated with the first communication technology or the second communication technology or both, one or more frame offsets between the first communication technology and the second communication technology, and one or more slot durations or frame lengths associated with the first communication technology or the second communication technology or both, or any combination thereof; and determining a timing for receiving the first message using the second communication technology based at least in part on any combination of the one or more system frame numbers, the one or more frame offsets, and the one or more slot durations or frame lengths, wherein receiving the first message is based at least in part on determining the timing.
Aspect 11: The method of any of aspects 1 through 10, further comprising: aligning a timing associated with the first communication technology and a timing associated with the second communication technology, wherein the resource mapping between the first set of time resources for downlink communications using the first communication technology and the second set of time resources for downlink communications using the second communication technology is based at least in part on the aligning.
Aspect 12: The method of any of aspects 1 through 11, further comprising: determining a first offset between a time resource associated with the first communication technology and a time resource associated with the second communication technology; determining a second offset between the time resource associated with the first communication technology and the time resource associated with the second communication technology; and determining a difference between the first offset and the second offset corresponding to a timing drift between the first communication technology and the second communication technology.
Aspect 13: The method of aspect 12, further comprising: transmitting an indication of the timing drift to the first network device based at least in part on determining the difference associated with the timing drift; and adjusting the resource mapping based at least in part on the timing drift satisfying a threshold.
Aspect 14: The method of any of aspects 1 through 13, wherein the first network device comprises a base station and the second network device comprises a visible light communications access point.
Aspect 15: The method of any of aspects 1 through 13, wherein the first communication technology comprises a radio access technology and the second communication technology comprises visible light communications.
Aspect 16: The method of any of aspects 1 through 15, further comprising: establishing a first communication link with the first network device using the first communication technology; and establishing a second communication link with the second network device using the second communication technology, wherein one or more time resources associated with the first communication link are asynchronous with one or more time resources associated with the second communication link.
Aspect 17: A method for wireless communication at a first network device, comprising: determining a resource mapping between a first set of time resources for downlink communications using a first communication technology and a second set of time resources for downlink communications using a second communication technology; transmitting, to a UE using the first communication technology, an indication of the resource mapping; and monitoring for one or more messages from the UE based at least in part on the resource mapping.
Aspect 18: The method of aspect 17, further comprising: receiving, from the UE, a second message using the first communication technology based at least in part on the UE receiving a first message using the second communication technology from a second network device; and transmitting, via a backhaul connection, to the second network device, feedback information associated with the first message based at least in part on receiving the second message from the UE.
Aspect 19: The method of aspect 18, further comprising: transmitting, to the UE, one or more retransmissions of the first message using the first communication technology, wherein the one or more retransmissions of the first message are transmitted based at least in part on receiving the second message comprising feedback information.
Aspect 20: The method of any of aspects 18 through 19, further comprising: transmitting, to the UE using the first communication technology, control signaling indicating a delay associated with messages communicated using the second communication technology relative to the first communication technology, wherein the delay is associated with the UE receiving the first message using the second communication technology.
Aspect 21: The method of any of aspects 17 through 20, wherein transmitting the indication of the resource mapping further comprises: transmitting, an indication that the first set of time resources for downlink communications using the first communication technology is mapped to the second set of time resources for downlink communications using the second communication technology, wherein monitoring for one or more messages from the UE is based at least in part on transmitting the indication.
Aspect 22: The method of any of aspects 17 through 20, wherein transmitting the indication of the resource mapping further comprises: transmitting, an indication that the second set of time resources for downlink communications using the second communication technology is mapped to a third set of time resources for uplink communications using the first communication technology; and receiving, from the UE, a second message using the first communication technology based at least in part on transmitting the indication, wherein the second message comprises feedback information associated with a first message received from a second network device using the second communication technology.
Aspect 23: The method of any of aspects 17 through 20, wherein transmitting the indication of the resource mapping further comprises: transmitting, as part of the indication, one or more system frame numbers associated with the first communication technology or the second communication technology or both, one or more frame offsets between the first communication technology and the second communication technology, and one or more slot durations or frame lengths associated with the first communication technology or the second communication technology or both, or any combination thereof.
Aspect 24: The method of any of aspects 17 through 23, further comprising: aligning a timing associated with the first communication technology and a timing associated with the second communication technology, wherein the resource mapping between the first set of time resources for downlink communications using the first communication technology and the second set of time resources for downlink communications using the second communication technology is based at least in part on the aligning.
Aspect 25: The method of any of aspects 17 through 24, further comprising: receiving, from the UE, an indication of a timing drift corresponding to a measured difference between a first offset and a second offset; and adjusting the resource mapping based at least in part on the timing drift satisfying a threshold.
Aspect 26: The method of any of aspects 17 through 25, further comprising: receiving, from the UE, using the first communication technology, a third message comprising feedback information associated with messages received from the first network device using the first communication technology.
Aspect 27: The method of aspect 26, wherein the third message and a second message are received using a time-division multiplexing pattern based at least in part on a single Tx capability of the UE.
Aspect 28: A method for wireless communication at a second network device, comprising: receiving, from a first network device using a first communication technology, an indication of a resource mapping between a first set of time resources for downlink communications using the first communication technology and a second set of time resources for downlink communications using a second communication technology; determining a timing for transmitting a first message to a UE using the second communication technology based at least in part on receiving the indication of the resource mapping; and transmitting, to the UE, the first message using the second communication technology.
Aspect 29: The method of aspect 28, further comprising: receiving, from the first network device, via a backhaul connection, feedback information associated with the first message.
Aspect 30: An apparatus for wireless communication at a UE, comprising a processor; memory coupled with the processor; and instructions stored in the memory and executable by the processor to cause the apparatus to perform a method of any of aspects 1 through 16.
Aspect 31: An apparatus for wireless communication at a UE, comprising at least one means for performing a method of any of aspects 1 through 16.
Aspect 32: A non-transitory computer-readable medium storing code for wireless communication at a UE, the code comprising instructions executable by a processor to perform a method of any of aspects 1 through 16.
Aspect 33: An apparatus for wireless communication at a first network device, comprising a processor; memory coupled with the processor; and instructions stored in the memory and executable by the processor to cause the apparatus to perform a method of any of aspects 17 through 27.
Aspect 34: An apparatus for wireless communication at a first network device, comprising at least one means for performing a method of any of aspects 17 through 27.
Aspect 35: A non-transitory computer-readable medium storing code for wireless communication at a first network device, the code comprising instructions executable by a processor to perform a method of any of aspects 17 through 27.
Aspect 36: An apparatus for wireless communication at a second network device, comprising a processor; memory coupled with the processor; and instructions stored in the memory and executable by the processor to cause the apparatus to perform a method of any of aspects 28 through 29.
Aspect 37: An apparatus for wireless communication at a second network device, comprising at least one means for performing a method of any of aspects 28 through 29.
Aspect 38: A non-transitory computer-readable medium storing code for wireless communication at a second network device, the code comprising instructions executable by a processor to perform a method of any of aspects 28 through 29.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving, from a first network device using a first communication technology, an indication of a resource mapping between a first set of time resources for downlink communications using the first communication technology and a second set of time resources for downlink communications using a second communication technology;
determining a timing for receiving a first message from a second network device using the second communication technology based at least in part on receiving the indication of the resource mapping; and
receiving, from the second network device, the first message using the second communication technology based at least in part on determining the timing.

2. The method of claim 1, further comprising:
transmitting, to the first network device, a second message using the first communication technology based at least in part on receiving the first message from the second network device using the second communication technology, the second message comprising feedback information associated with the first message received from the second network device using the second communication technology.

3. The method of claim 2, further comprising:
receiving, from the first network device, one or more retransmissions of the first message using the first communication technology, wherein the one or more retransmissions are received based at least in part on transmitting the second message comprising the feedback information.

4. The method of claim 2, further comprising:
transmitting, to the first network device using the first communication technology, a third message comprising feedback information associated with messages received from the first network device using the first communication technology.

5. The method of claim 4, wherein the third message and the second message are transmitted using a time-division multiplexing pattern based at least in part on a single Tx capability of the UE.

6. The method of claim 4, wherein the third message and the second message are transmitted simultaneously based at least in part on a dual-Tx capability of the UE.

7. The method of claim 1, further comprising:
receiving, from the first network device using the first communication technology, control signaling indicating a delay associated with messages communicated using the second communication technology relative to the first communication technology, wherein receiving the first message using the second communication technology is based at least in part on receiving the control signaling.

8. The method of claim 1, wherein receiving the indication of the resource mapping further comprises:
receiving an indication that the first set of time resources for downlink communications using the first communication technology is mapped to the second set of time resources for downlink communications using the second communication technology, wherein receiving, from the second network device, the first message using the second communication technology is based at least in part on receiving the indication.

9. The method of claim 1, wherein receiving the indication of the resource mapping further comprises:
receiving an indication that the second set of time resources for downlink communications using the second communication technology is mapped to a third set of time resources for uplink communications using the first communication technology; and
transmitting, to the first network device, a second message using the first communication technology based at least in part on receiving the indication, wherein the second message comprises feedback information associated with the first message received from the second network device using the second communication technology.

10. The method of claim 1, wherein receiving the indication of the resource mapping further comprises:
receiving, as part of the indication, one or more system frame numbers associated with the first communication technology or the second communication technology or both, one or more frame offsets between the first communication technology and the second communication technology, and one or more slot durations or frame lengths associated with the first communication technology or the second communication technology or both, or any combination thereof; and
determining a timing for receiving the first message using the second communication technology based at least in part on any combination of the one or more system frame numbers, the one or more frame offsets, and the one or more slot durations or frame lengths, wherein receiving the first message is based at least in part on determining the timing.

11. The method of claim 1, further comprising:
aligning a timing associated with the first communication technology and a timing associated with the second communication technology, wherein the resource mapping between the first set of time resources for downlink communications using the first communication technology and the second set of time resources for downlink communications using the second communication technology is based at least in part on the aligning.

12. The method of claim 1, further comprising:
determining a first offset between a time resource associated with the first communication technology and a time resource associated with the second communication technology;
determining a second offset between the time resource associated with the first communication technology and the time resource associated with the second communication technology; and
determining a difference between the first offset and the second offset corresponding to a timing drift between the first communication technology and the second communication technology.

13. The method of claim 12, further comprising:
transmitting an indication of the timing drift to the first network device based at least in part on determining the difference associated with the timing drift; and
adjusting the resource mapping based at least in part on the timing drift satisfying a threshold.

14. The method of claim 1, wherein the first network device comprises a base station and the second network device comprises a visible light communications access point.

15. The method of claim 1, wherein the first communication technology comprises a radio access technology and the second communication technology comprises visible light communications.

16. The method of claim 1, further comprising:
establishing a first communication link with the first network device using the first communication technology; and
establishing a second communication link with the second network device using the second communication technology, wherein one or more time resources associated with the first communication link are asynchronous with one or more time resources associated with the second communication link.

17. A method for wireless communication at a first network device, comprising:
determining a resource mapping between a first set of time resources for downlink communications using a first communication technology and a second set of time resources for downlink communications using a second communication technology;
transmitting, to a user equipment (UE) using the first communication technology, an indication of the resource mapping; and
monitoring for one or more messages from the UE based at least in part on the resource mapping.

18. The method of claim 17, further comprising:
receiving, from the UE, a second message using the first communication technology based at least in part on the UE receiving a first message using the second communication technology from a second network device; and
transmitting, via a backhaul connection, to the second network device, feedback information associated with the first message based at least in part on receiving the second message from the UE.

19. The method of claim 18, further comprising:
transmitting, to the UE, one or more retransmissions of the first message using the first communication technology, wherein the one or more retransmissions of the first message are transmitted based at least in part on receiving the second message comprising the feedback information.

20. The method of claim 18, further comprising:
transmitting, to the UE using the first communication technology, control signaling indicating a delay associated with messages communicated using the second communication technology relative to the first communication technology, wherein the delay is associated with the UE receiving the first message using the second communication technology.

21. The method of claim 17, wherein transmitting the indication of the resource mapping further comprises:
transmitting, an indication that the first set of time resources for downlink communications using the first communication technology is mapped to the second set of time resources for downlink communications using the second communication technology, wherein monitoring for the one or more messages from the UE is based at least in part on transmitting the indication.

22. The method of claim 17, wherein transmitting the indication of the resource mapping further comprises:
transmitting, an indication that the second set of time resources for downlink communications using the second communication technology is mapped to a third set of time resources for uplink communications using the first communication technology; and
receiving, from the UE, a second message using the first communication technology based at least in part on transmitting the indication, wherein the second message comprises feedback information associated with a first message received from a second network device using the second communication technology.

23. The method of claim 17, wherein transmitting the indication of the resource mapping further comprises:
transmitting, as part of the indication, one or more system frame numbers associated with the first communication technology or the second communication technology or both, one or more frame offsets between the first communication technology and the second communication technology, and one or more slot durations or frame lengths associated with the first communication technology or the second communication technology or both, or any combination thereof.

24. The method of claim 17, further comprising:
aligning a timing associated with the first communication technology and a timing associated with the second communication technology, wherein the resource mapping between the first set of time resources for downlink communications using the first communication technology and the second set of time resources for downlink communications using the second communication technology is based at least in part on the aligning.

25. The method of claim 17, further comprising:
receiving, from the UE, an indication of a timing drift corresponding to a measured difference between a first offset and a second offset; and
adjusting the resource mapping based at least in part on the timing drift satisfying a threshold.

26. The method of claim 17, further comprising:
receiving, from the UE, using the first communication technology, a third message comprising feedback information associated with messages received from the first network device using the first communication technology.

27. The method of claim 26, wherein the third message and a second message are received using a time-division multiplexing pattern based at least in part on a single Tx capability of the UE.

28. A method for wireless communication at a second network device, comprising:
receiving, from a first network device using a first communication technology, an indication of a resource mapping between a first set of time resources for downlink communications using the first communication technology and a second set of time resources for downlink communications using a second communication technology;
determining a timing for transmitting a first message to a user equipment (UE) using the second communication technology based at least in part on receiving the indication of the resource mapping; and
transmitting, to the UE, the first message using the second communication technology.

29. The method of claim 28, further comprising:
receiving, from the first network device, via a backhaul connection, feedback information associated with the first message.

30. An apparatus for wireless communication, comprising:
a processor;
memory coupled with the processor; and
instructions stored in the memory and executable by the processor to cause the apparatus to:
receive, from a first network device using a first communication technology, an indication of a resource mapping between a first set of time resources for downlink communications using the first communication technology and a second set of time resources for downlink communications using a second communication technology;
determine a timing for receiving a first message from a second network device using the second communication technology based at least in part on receiving the indication of the resource mapping; and
receive, from the second network device, the first message using the second communication technology based at least in part on determining the timing.
